(19) United States
(12) Patent Application Publication
(10) Pub. No.: US 2025/0108339 A1
(43) Pub. Date: Apr. 3, 2025

(54) ALKANOLAMINE-CONTAINING MEMBRANES AND METHODS OF MAKING AND USING THEREOF

(71) Applicant: Ohio State Innovation Foundation, Columbus, OH (US)

(72) Inventors: W.S. Winston HO, Columbus, OH (US); Yang HAN, Columbus, OH (US)

(21) Appl. No.: 18/730,155

(22) PCT Filed: Jan. 17, 2023
(86) PCT No.: PCT/US23/60767

§ 371 Date: Jul. 18, 2024

Related U.S. Application Data
(60) Provisional application No. 63/300,450, filed on Jan. 18, 2022.

(51) Int. Cl. B01D 69/14; B01D 53/22; B01D 69/02; B01D 69/10; B01D 71/38; B01D 71/52; B01D 71/68

(52) U.S. Cl. CPC B01D 69/142; B01D 53/228; B01D 69/02; B01D 69/1071; B01D 69/14111; B01D 71/381; B01D 71/521; B01D 71/68; B01D 2256/16; B01D 2257/304; B01D 2257/504; B01D 2325/36

(57) ABSTRACT

Membranes, methods of making the membranes, and methods of using the membranes are described herein. The membrane can include a support layer; and a selective polymer layer disposed on the support layer. The selective polymer layer can include a selective polymer matrix that comprises a mobile carrier comprising an alkanolamine or a salt thereof. The selective polymer matrix can further comprise, for example, a hydrophilic polymer, a cross-linking agent, a low molecular weight amino compound, an amine-containing polymer, a CO₂-philic ether, or a combination thereof. In some embodiments, the selective polymer matrix can further comprise graphene oxide dispersed within the selective polymer matrix. The membranes can be used to separate carbon dioxide from hydrogen. Also provided are methods of purifying syngas using the membranes described herein.

### CROSS REFERENCE TO RELATED APPLICATIONS

This application claims benefit of U.S. Provisional Application No. 63/300,450, filed Jan. 18, 2022, which is hereby incorporated by reference in its entirety.

### STATEMENT REGARDING FEDERALLY SPONSORED RESEARCH OR DEVELOPMENT

This disclosure was made with Government Support under Grant No. DE-FE0031635 awarded by U.S. Department of Energy. The Government has certain rights to this disclosure.

### BACKGROUND

There has been growing concern about global warming since the CO₂ concentration in the atmosphere has surpassed 400 ppm in the past decade. The combustion of fossil fuels is one of the major contributors to the large amount of CO₂ emissions, and membrane technologies have been suggested as a promising approach to capture CO₂ from large stationary sources, followed by compression for geological sequestration and other applications. As one approach to produce large-scale electricity, coal can be gasified into a cleaner syngas, which can then be used to produce electricity via gas turbines or fuel cells. To capture CO₂ before deriving energy or to produce pure H₂ as a preferred chemical feedstock, the syngas can be subjected to a water-gas shift (WGS) reaction. In this scheme, typically named as integrated gasification combined cycle (IGCC), CO₂ has to be separated from H₂. Other minor components, including water vapor and H₂S, also need to be removed. Accordingly, improved methods of separating CO₂ and H₂ are needed. The compositions and methods disclosed herein address these and other needs.

### SUMMARY

Disclosed are membranes that include a support layer and a selective polymer layer disposed on the support layer.

The support layer can be a gas permeable layer comprising a gas permeable polymer. The gas permeable polymer can comprise a polyamide, a polyimide, a polypyrrolone, a polyester, a sulfone-based polymer (e.g., a polysulfone, or a polyethersulfone), a polymeric organosilicone, a fluorinated polymer, a polyolefin, a copolymer thereof, or a blend thereof. In some cases, the gas permeable polymer can comprise a polysulfone. In some embodiments, the gas permeable polymer can comprise a polyethersulfone. In certain cases, the support layer can comprise a gas permeable polymer disposed on a base (e.g., a nonwoven fabric such as a polyester nonwoven).

The selective polymer matrix can comprise a mobile carrier comprising an alkanolamine or a salt thereof. The selective polymer matrix can further comprise, for example, a hydrophilic polymer, a cross-linking agent, a low molecular weight amino compound, an amine-containing polymer, a CO₂-philic ether, or a combination thereof. In some embodiments, the selective polymer matrix can further comprise graphene oxide dispersed within the selective polymer matrix.

In some embodiments, the mobile carrier (e.g., the alkanolamine or a salt thereof) can have a molecular weight of less than 1,000 Da.

In some embodiments, the mobile carrier comprises an alkanolamine, such as a compound defined by the structure below:

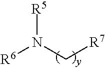

wherein
R⁵ and R⁶ are independently selected from hydrogen, alkyl, —ROH, —RNR⁵R⁶, or R⁵ and R⁶, together with the atoms to which they are attached, combine to form a 3 to 7 membered heterocycle;
R⁷ is —OH, —O—R—OH, or —R—OH;
R is alkyl;
y is an integer from 1 to 4; and
   wherein at least one of R⁵-R⁷ comprises a hydroxy group.

In certain embodiments, the alkanolamine can comprise one of the following:

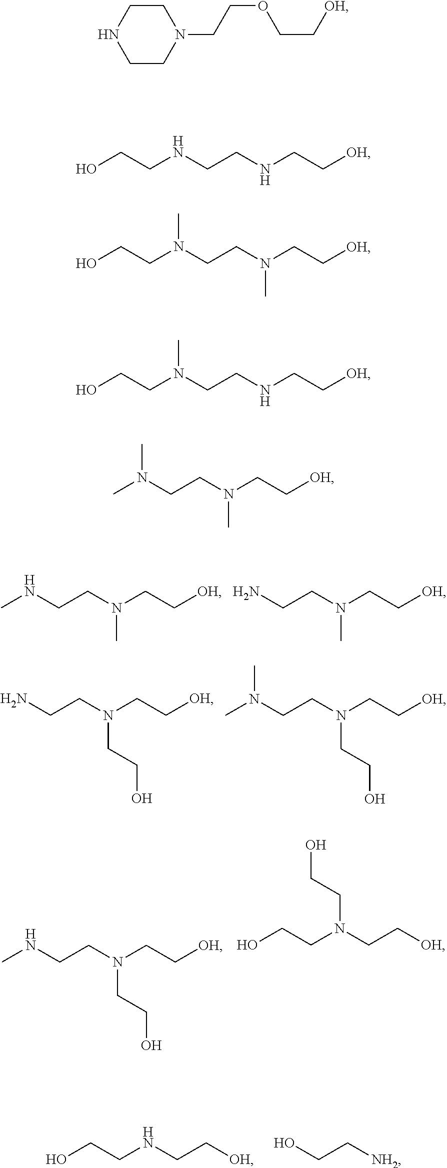

or a combination thereof.

In some embodiments, the mobile carrier can comprise an alkanolamine salt, such as an alkanolamine salt of an amino acid.

In some examples, the amino acid can comprise a compound defined by the formula below

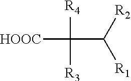

wherein, independently for each occurrence in the amino acid, each of R₁, R₂, R₃ and R₄ is selected from one of the following

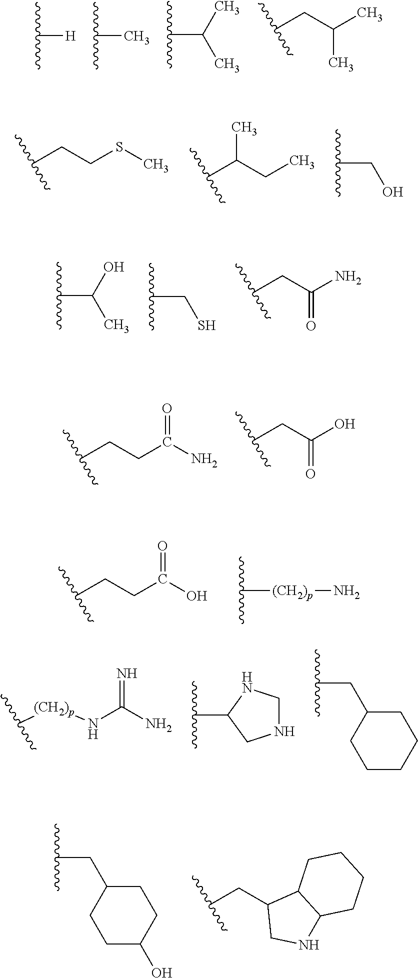

wherein at least one of R₁-R₄ comprises an amino group,
or R₁ and R₃, together with the atoms to which they are attached, form a five-membered heterocycle defined by the structure below when n is 1, or a six-membered heterocycle defined by the structure below when n is 2

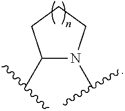

In some examples, the alkanolamine salt can comprise an alkanolamine defined by the structure below:

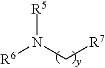

wherein
R⁵ and R⁶ are independently selected from hydrogen, alkyl, —ROH, —RNR⁵R⁶, or R⁵ and R⁶, together with the atoms to which they are attached, combine to form a 3 to 7 membered heterocycle;
R⁷ is —OH, —O—R—OH, or —R—OH;
R is alkyl;
y is an integer from 1 to 4; and
   wherein at least one of R⁵-R⁷ comprises a hydroxy group.

In some examples, the alkanolamine salt can comprise an alkanolamine-glycinate salt, an alkanolamine-sarcosinate salt, or an alkanolamine-aminoisobutyrate salt.

In some examples, the alkanolamine salt can comprise monoethanolamine 2-aminoisobutyrate (MEA-AIBA), 2-(2-hydroxyethoxy)ethylamine 2-aminoisobutyrate (HEEA-AIBA), hydroxyethyl piperazine 2-aminoisobutyrate (HEPZ-AIBA), monoethanolamine sarcosinate (MEA-Sar), 2-(2-hydroxyethoxy)ethylamine sarcosinate (HEEA-Sar), and 1-(2-hydroxyethyl)piperazine sarcosinate (HEPZ-Sar), monoethanolamine glycinate (MEA-Gly), 2-(2-hydroxyethoxy)ethylamine glycinate (HEEA-Gly), 1-(2-hydroxyethyl)piperazine glycinate (HEPZ-Gly), diethanolamine 2-aminoisobutyrate (DEA-AIBA), diethanolamine sarconsinate (DEA-Sar), diethanolamine glycinate (DEA-Gly), triethanolamine 2-aminoisobutyrate (TEA-AIBA), triethanolamine sarconsinate (TEA-Sar), triethanolamine glycinate (TEA-Gly), or a combination thereof.

In some embodiments, the alkanolamine salt can be defined by a general formula below

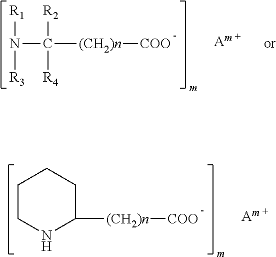

wherein R₁, R₂, R₃, and R₄ are hydrogen or hydrocarbon groups having from 1 to 4 carbon atoms, n is an integer ranging from 0 to 4, and
A^{m+} is defined by the formula below

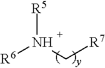

wherein
R⁵ and R⁶ are independently selected from hydrogen, alkyl, —ROH, —RNR⁵R⁶, or R⁵ and R⁶, together with the atoms to which they are attached, combine to form a 3 to 7 membered heterocycle;
R⁷ is —OH, —O—R—OH, or —R—OH;
R is alkyl;
y is an integer from 1 to 4; and
   wherein at least one of R⁵-R⁷ comprises a hydroxy group.

The membranes can be used to separate carbon dioxide from hydrogen. The membranes can exhibit selective permeability towards gases, such as carbon dioxide. In certain embodiments, the membranes can exhibit a CO₂:H₂ selectivity of at least 50 (e.g., from 50 to 500) at 107° C. and a feed pressure of 15-40 bar (e.g., 35 bar).

Also provided are methods for separating a first gas from a feed gas stream using the membranes described. These methods can include contacting a membrane described with the feed gas stream including the first gas under conditions effective to afford transmembrane permeation of the first gas. The feed gas can include hydrogen, carbon dioxide, hydrogen sulfide, carbon monoxide, nitrogen, methane, steam, or combinations thereof.

In some embodiments, the first gas is chosen from carbon dioxide, hydrogen sulfide, and combinations thereof. In some of these embodiments, the feed gas can include a second gas such as nitrogen, hydrogen, carbon monoxide, or combinations thereof. The membrane can exhibit a first gas/second gas selectivity of from 50 to 500 at 107° C. and a feed pressure of 15-40 bar (e.g., 35 bar).

In certain embodiments, the feed gas includes syngas. The first gas can include carbon dioxide and the second gas can include hydrogen. In these embodiments, the membranes described can be employed, for example, to decarbonize coal-derived syngas.

Also provided are methods of making a membrane that includes depositing a selective polymer layer on a support layer, the selective polymer layer comprising a selective polymer matrix and optionally a graphene oxide dispersed within the selective polymer matrix.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 shows the chemical structure of the main chemicals.

FIG. 2 shows TGA curves for PZ and PZEA in the presence of N₂ purge.

FIG. 3A-3B show stability of membranes containing (3A) MEA-Sar and (3B) HEPZ-AIBA as mobile carriers.

FIG. 4A-4C show stability of membranes containing (4A) HEEPZ, (4B) BHEEDA, and (4C) DMBHEEDA as mobile carriers.

### DETAILED DESCRIPTION

Because of the high CO₂/H₂ selectivity, amine-containing polymeric membranes are a promising technology for efficient hydrogen purification. One potential advantage of utilizing membranes to remove CO₂ in IGCC is that the syngas is typically delivered at a high pressure up to 50 bar with a considerable CO₂ concentration of 30-40%. The high CO₂ partial pressure provides a sufficient transmembrane driving force for selective CO₂ removal without incurring additional energy penalty. However, several engineering issues hinder the operation of these amine-containing membranes at high feed pressure. Firstly, the CO₂ permeance of the membrane tends to reduce with increasing feed pressure, owing to the saturation of amine carriers under a CO₂ high partial pressure, i.e., the carrier saturation phenomenon. Sophisticated understanding and design of the amine-CO₂ chemistry are required to achieve a highly selective membrane performance in the syngas separation modality. Secondly, the high feed pressure might compress the polymer material, which leads to membrane densification, thereby a reduced CO₂ permeance. Several inorganic nanofillers have been proposed to mitigate the membrane compaction, but none of them has demonstrated the feasibility at a feed pressure relevant to syngas purification.

A number of embodiments of the disclosure have been described. Nevertheless, it will be understood that various modifications may be made without departing from the spirit and scope of the invention. Accordingly, other embodiments are within the scope of the following claims. Disclosed herein are membrane with extraordinary CO₂/H₂ separation performances at high CO₂ partial pressure.

In some embodiments, the selective polymer matrix can comprise a mobile carrier comprising an alkanolamine or a salt thereof to facilitate the transport of CO₂. The selective layer of the membrane can further include, for example, a fixed carrier (e.g., an amine-containing polymer such as a polyvinylamine) and crosslinked polyvinylalcohol as the polymer matrix. In certain compositions, CO₂-philic moiety based on the hydroxyethyl group (HO—CH₂—CH₂—) are also incorporated to enhance the CO₂ solubility. To address the membrane compaction issue, a small amount of nanoporous graphene oxide is dispersed as a two-dimensional reinforcement filler.

Accordingly, membranes, methods of making the membranes, and methods of using the membranes are described herein. The membranes can comprise a support layer, and a selective polymer layer disposed on the support layer.

### Definitions

To facilitate understanding of the disclosure set forth herein, a number of terms are defined below. Unless defined otherwise, all technical and scientific terms used herein generally have the same meaning as commonly understood by one of ordinary skill in the art to which this disclosure belongs. Publications cited herein and the materials for which they are cited are specifically incorporated by reference.

### General Definitions

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Other than where noted, all numbers expressing quantities of ingredients, reaction conditions, geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Accordingly, these terms are intended to not only cover the recited element(s) or step(s), but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. A range may be construed to include the start and the end of the range. For example, a range of 10% to 20% (i.e., range of 10%-20%) can includes 10% and also includes 20%, and includes percentages in between 10% and 20%, unless explicitly stated otherwise herein.

As used herein, the terms “may”, “optionally”, and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

A “control” is an alternative subject or sample used in an experiment for comparison purposes. A control can be “positive” or “negative”.

### Chemical Definitions

Terms used herein will have their customary meaning in the art unless specified otherwise. The organic moieties mentioned when defining variable positions within the general formulae described herein (e.g., the term “halogen”) are collective terms for the individual substituents encompassed by the organic moiety. Ph in Formula I refers to a phenyl group.

As used herein, “alkyl” means a straight or branched chain saturated hydrocarbon moieties such as those containing from 1 to 10 carbon atoms. A “higher alkyl” refers to saturated hydrocarbon having 11 or more carbon atoms. A “C₆-C₁₆” refers to an alkyl containing 6 to 16 carbon atoms. Likewise, a “C₆-C₂₂” refers to an alkyl containing 6 to 22 carbon atoms. Representative saturated straight chain alkyls include methyl, ethyl, n-propyl, n-butyl, n-pentyl, n-hexyl, n-heptyl, n-octyl, n-nonyl, and the like; while saturated branched alkyls include isopropyl, sec-butyl, isobutyl, tert-butyl, isopentyl, and the like.

As used herein, the term “alkenyl” refers to unsaturated, straight or branched hydrocarbon moieties containing a double bond. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, or C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure —CH═CH—CH₃; and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C.

As used herein, the term “alkynyl” represents straight or branched hydrocarbon moieties containing a triple bond. Unless otherwise specified, C₂-C₂₄ (e.g., C₂-C₂₄, C₂-C₂₀, C₂-C₁₈, C₂-C₁₆, C₂-C₁₄, C₂-C₁₂, C₂-C₁₀, C₂-C₈, C₂-C₆, or C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl.

Non-aromatic mono or polycyclic alkyls are referred to herein as “carbocycles” or “carbocyclyl” groups. Representative saturated carbocycles include cyclopropyl, cyclobutyl, cyclopentyl, cyclohexyl, and the like; while unsaturated carbocycles include cyclopentenyl and cyclohexenyl, and the like.

“Heterocarbocycles” or “heterocarbocyclyl” groups are carbocycles which contain from 1 to 4 heteroatoms independently selected from nitrogen, oxygen and sulfur which can be saturated or unsaturated (but not aromatic), monocyclic or polycyclic, and wherein the nitrogen and sulfur heteroatoms can be optionally oxidized, and the nitrogen heteroatom can be optionally quaternized. Heterocarbocycles include morpholinyl, pyrrolidinonyl, pyrrolidinyl, piperidinyl, hydantoinyl, valerolactamyl, oxiranyl, oxetanyl, tetrahydrofuranyl, tetrahydropyranyl, tetrahydropyridinyl, tetrahydroprimidinyl, tetrahydrothiophenyl, tetrahydrothiopyranyl, tetrahydropyrimidinyl, tetrahydrothiophenyl, tetrahydrothiopyranyl, and the like.

The term “aryl” refers to aromatic homocyclic (i.e., hydrocarbon) mono-, bi- or tricyclic ring-containing groups preferably having 6 to 12 members such as phenyl, naphthyl and biphenyl. Phenyl is a preferred aryl group. The term “substituted aryl” refers to aryl groups substituted with one or more groups, preferably selected from alkyl, substituted alkyl, alkenyl (optionally substituted), aryl (optionally substituted), heterocyclo (optionally substituted), halo, hydroxy, alkoxy (optionally substituted), aryloxy (optionally substituted), alkanoyl (optionally substituted), aroyl, (optionally substituted), alkylester (optionally substituted), arylester (optionally substituted), cyano, nitro, amino, substituted amino, amido, lactam, urea, urethane, sulfonyl, and, the like, where optionally one or more pair of substituents together with the atoms to which they are bonded form a 3 to 7 member ring.

As used herein, “heteroaryl” or “heteroaromatic” refers an aromatic heterocarbocycle having 1 to 4 heteroatoms selected from nitrogen, oxygen and sulfur, and containing at least 1 carbon atom, including both mono- and polycyclic ring systems.

Polycyclic ring systems can, but are not required to, contain one or more non-aromatic rings, as long as one of the rings is aromatic. Representative heteroaryls are furyl, benzofuranyl, thiophenyl, benzothiophenyl, pyrrolyl, indolyl, isoindolyl, azaindolyl, pyridyl, quinolinyl, isoquinolinyl, oxazolyl, isooxazolyl, benzoxazolyl, pyrazolyl, imidazolyl, benzimidazolyl, thiazolyl, benzothiazolyl, isothiazolyl, pyridazinyl, pyrimidinyl, pyrazinyl, triazinyl, cinnolinyl, phthalazinyl, and quinazolinyl. It is contemplated that the use of the term “heteroaryl” includes N-alkylated derivatives such as a 1-methylimidazol-5-yl substituent.

As used herein, “heterocycle” or “heterocyclyl” refers to mono- and polycyclic ring systems having 1 to 4 heteroatoms selected from nitrogen, oxygen and sulfur, and containing at least 1 carbon atom. The mono- and polycyclic ring systems can be aromatic, non-aromatic or mixtures of aromatic and non-aromatic rings. Heterocycle includes heterocarbocycles, heteroaryls, and the like.

“Alkylthio” refers to an alkyl group as defined above with the indicated number of carbon atoms attached through a sulfur bridge. An example of an alkylthio is methylthio, (i.e., —S—CH₃).

“Alkoxy” refers to an alkyl group as defined above with the indicated number of carbon atoms attached through an oxygen bridge. Examples of alkoxy include, but are not limited to, methoxy, ethoxy, n-propoxy, i-propoxy, n-butoxy, s-butoxy, t-butoxy, n-pentoxy, and s-pentoxy. Preferred alkoxy groups are methoxy, ethoxy, n-propoxy, i-propoxy, n-butoxy, s-butoxy, t-butoxy.

“Alkylamino” refers an alkyl group as defined above with the indicated number of carbon atoms attached through an amino bridge. An example of an alkylamino is methylamino, (i.e., —NH—CH₃).

“Alkanoyl” refers to an alkyl as defined above with the indicated number of carbon atoms attached through a carbonyl bride (i.e., —(C═O)alkyl).

“Alkylsulfonyl” refers to an alkyl as defined above with the indicated number of carbon atoms attached through a sulfonyl bridge (i.e., —S(═O)₂alkyl) such as mesyl and the like, and “Arylsulfonyl” refers to an aryl attached through a sulfonyl bridge (i.e., —S(═O)₂aryl).

“Alkylsulfamoyl” refers to an alkyl as defined above with the indicated number of carbon atoms attached through a sulfamoyl bridge (i.e., —NHS(═O)₂alkyl), and an “Arylsulfamoyl” refers to an alkyl attached through a sulfamoyl bridge (i.e., —NHS(═O)₂aryl).

“Alkylsulfinyl” refers to an alkyl as defined above with the indicated number of carbon atoms attached through a sulfinyl bridge (i.e. —S(═O)alkyl).

The terms “cycloalkyl” and “cycloalkenyl” refer to mono-, bi-, or tri homocyclic ring groups of 3 to 15 carbon atoms which are, respectively, fully saturated and partially unsaturated. The term “cycloalkenyl” includes bi- and tricyclic ring systems that are not aromatic as a whole, but contain aromatic portions (e.g., fluorene, tetrahydronapthalene, dihydroindene, and the like). The rings of multi-ring cycloalkyl groups can be either fused, bridged and/or joined through one or more spiro unions. The terms “substituted cycloalkyl” and “substituted cycloalkenyl” refer, respectively, to cycloalkyl and cycloalkenyl groups substituted with one or more groups, preferably selected from aryl, substituted aryl, heterocyclo, substituted heterocyclo, carbocyclo, substituted carbocyclo, halo, hydroxy, alkoxy (optionally substituted), aryloxy (optionally substituted), alkylester (optionally substituted), arylester (optionally substituted), alkanoyl (optionally substituted), aryol (optionally substituted), cyano, nitro, amino, substituted amino, amido, lactam, urea, urethane, sulfonyl, and the like.

The terms “halogen” and “halo” refer to fluorine, chlorine, bromine, and iodine.

The term “substituted” refers to a molecule wherein at least one hydrogen atom is replaced with a substituent. When substituted, one or more of the groups are “substituents”. The molecule can be multiply substituted. In the case of an oxo substituent (“═O”), two hydrogen atoms are replaced. Example substituents within this context can include halogen, hydroxy, alkyl, alkoxy, nitro, cyano, oxo, carbocyclyl, carbocycloalkyl, heterocarbocyclyl, heterocarbocycloalkyl, aryl, arylalkyl, heteroaryl, heteroarylalkyl, —NRaRb, —NRaC(═O)Rb, —NRaC(═O)NRaNRb, —NRaC(═O)ORb, —NRaSO₂Rb, —C(═O)Ra, —C(═O)ORa, —C(═O)NRaRb, —OC(═O)NRaRb, —ORa, —SRa, —SORa, —S(═O)₂Ra, —OS(═O)₂Ra and —S(═O)₂ORa. Ra and Rb in this context can be the same or different and independently hydrogen, halogen hydroxyl, alkyl, alkoxy, alkyl, amino, alkylamino, dialkylamino, carbocyclyl, carbocycloalkyl, heterocarbocyclyl, heterocarbocycloalkyl, aryl, arylalkyl, heteroaryl, heteroarylalkyl.

The term “optionally substituted”, as used herein, means that substitution with an additional group is optional and therefore it is possible for the designated atom to be unsubstituted. Thus, by use of the term “optionally substituted” the disclosure includes examples where the group is substituted and examples where it is not.

Reference will now be made in detail to specific aspects of the disclosed materials, compounds, compositions, articles, and methods, examples of which are illustrated in the accompanying Examples and Figures.

### Membranes

Membranes, methods of making the membranes, and methods of using the membranes are described herein. The membranes can comprise a gas permeable support layer, and a selective polymer layer disposed on the gas permeable support layer. The gas permeable support layer and the selective polymer layer can optionally comprise one or more sub-layers.

In some embodiments, the membrane can have a CO₂:H₂ selectivity of at least 10 at 107° C. and a feed pressure of 15-40 bar (e.g., 35 bar). For example, the membrane can have a CO₂:H₂ selectivity of at least 25 (e.g., at least 50, at least 75, at least 100, at least 125, at least 150, at least 175, at least 200, at least 225, at least 250, at least 275, at least 300, at least 325, at least 350, at least 375, at least 400, at least 425, at least 450, or at least 475) at 107° C. and 35 bar feed pressure. In some embodiments, the membrane can have a CO₂:H₂ selectivity of 500 or less (e.g., 475 or less, 450 or less, 425 or less, 400 or less, 375 or less, 350 or less, 325 or less, 300 or less, 275 or less, 250 or less, 225 or less, 200 or less, 175 or less, 150 or less, 125 or less, 100 or less, 75 or less, 50 or less, or 25 or less) at 107° C. and 35 bar feed pressure.

In certain embodiments, the membrane can have a CO₂:H₂ selectivity ranging from any of the minimum values described above to any of the maximum values described above. For example, in certain embodiments, the membrane can have a CO₂:H₂ selectivity of from 10 to 500 at 107° C. and 35 bar feed pressure (e.g., from 10 to 400 at 107° C. and 35 bar feed pressure, from 75 to 400 at 107° C. and 35 bar feed pressure, from 100 to 400 at 107° C. and 35 bar feed pressure, from 10 to 350 at 107° C. and 35 bar feed pressure, from 75 to 350 at 107° C. and 35 bar feed pressure, from 100 to 350 at 107° C. and 35 bar feed pressure, from 10 to 250 at 107° C. and 35 bar feed pressure, from 75 to 250 at 107° C. and 35 bar feed pressure, from 50 to 500 at 107° C. and 35 bar feed pressure, from 50 to 250 at 107° C. and 35 bar feed pressure, or from 100 to 250 at 107° C. and 35 bar feed pressure). The CO₂:H₂ selectivity of the membrane can be measured using standard methods for measuring gas permeance known in the art, such as those described in the examples below.

In some embodiments, the membrane can have a CO₂ permeance of at least 50 GPU (e.g., 75 GPU or greater, 100 GPU or greater, 150 GPU or greater, 200 GPU or greater, 250 GPU or greater, 300 GPU or greater, 350 GPU or greater, 400 GPU or greater, or 450 GPU or greater) at 107° C. and a feed pressure of 15-40 bar (e.g., 35 bar).

In some embodiments, the membrane can have a CO₂ permeance of 500 GPU or less at 107° C. and 35 bar feed pressure (e.g., 450 GPU or less, 400 GPU or less, 350 GPU or less, 300 GPU or less, 250 GPU or less, 200 GPU or less, 150 GPU or less, 100 GPU or less, or 75 GPU or less).

The CO₂ permeance through the membrane can vary from any of the minimum values described above to any of the maximum values described above. For example, in some embodiments, the membrane can have a CO₂ permeance of from 50 GPU to 500 GPU at 107° C. and a feed pressure of 15-40 bar (e.g., 35 bar) (e.g., from 50 GPU to 400 GPU, from 50 GPU to 300 GPU, from 50 GPU to 250 GPU, from 100 GPU to 500 GPU, from 80 GPU to 300 GPU, from 100 GPU to 300 GPU, or from 80 GPU to 500 GPU).

In some embodiments, the membrane can exhibit a CO₂ permeance of from 50 GPU to 500 GPU at 107° C. and a feed pressure of 15-40 bar (e.g., 35 bar) (e.g., from 50 GPU to 400 GPU, from 50 GPU to 300 GPU, from 50 GPU to 250 GPU, from 100 GPU to 500 GPU, from 80 GPU to 300 GPU, from 100 GPU to 300 GPU, or from 80 GPU to 500 GPU) and a CO₂:H₂ selectivity of from 50 to 500 at 107° C. and a feed pressure of 15-40 bar (e.g., 35 bar) (e.g., from 10 to 400 at 107° C. and a feed pressure of 15-40 bar (e.g., 35 bar), from 75 to 400 at 107° C. and a feed pressure of 15-40 bar (e.g., 35 bar), from 100 to 400 at 107° C. and 35 bar feed pressure, from 10 to 350 at 107° C. and a feed pressure of 15-40 bar (e.g., 35 bar), from 75 to 350 at 107° C. and a feed pressure of 15-40 bar (e.g., 35 bar), from 100 to 350 at 107° C. and a feed pressure of 15-40 bar (e.g., 35 bar), from 10 to 250 at 107° C. and a feed pressure of 15-40 bar (e.g., 35 bar), from 75 to 250 at 107° C. and a feed pressure of 15-40 bar (e.g., 35 bar), from 50 to 500 at 107° C. and a feed pressure of 15-40 bar (e.g., 35 bar), from 50 to 250 at 107° C. and a feed pressure of 15-40 bar (e.g., 35 bar), or from 100 to 250 at 107° C. and a feed pressure of 15-40 bar (e.g., 35 bar)).

In some embodiments, the CO₂ permeance and CO₂:H₂ selectivity remains stable for 5 hours or more (e.g., 6 hours or more, 12 hours or more, 24 hours or more, 36 hours or more, 48 hours or more, 60 hours or more, 72 hours or more, 84 hours or more, 96 hours or more, or 108 hours or more). In some embodiments, the CO₂ permeance and CO₂:H₂ selectivity remains stable for 120 hours or less (e.g., 108 hours or less, 96 hours or less, 84 hours or less, 72 hours or less, 60 hours or less, 48 hours or less, 36 hours or less, 24 hours or less, 12 hours or less, 6 hours or less).

In certain embodiments, the CO₂ permeance and CO₂:H₂ selectivity remains stable for a period of time ranging from any of the minimum values described above to any of the maximum values described above. For example, in certain embodiments, the CO₂ permeance and CO₂:H₂ selectivity remains stable for from 5 hours to 120 hours, (e.g., from 12 hours to 120 hours, from 24 hours to 120 hours, from 36 hours to 120 hours, from 48 hours to 120 hours, from 60 hours to 120 hours, from 72 hours to 120 hours, from 84 hours to 120 hours, from 96 hours to 120 hours, from 108 to 120 hours, from 12 hours to 72 hours, from 12 hours to 60 hours, from 6 hours to 120 hours, from 6 hours to 72 hours, or from 6 hours to 36 hours).

### Gas Permeable Support Layer

The support layer can be formed from any suitable material. The material used to form the support layer can be chosen based on the end use application of the membrane. In some embodiments, the support layer can comprise a gas permeable polymer. The gas permeable polymer can be a cross-linked polymer, a phase separated polymer, a porous condensed polymer, or a blend thereof. Examples of suitable gas permeable polymers include polyamides, polyimides, polypyrrolones, polyesters, sulfone-based polymers, nitrile-based polymers, polymeric organosilicones, fluorinated polymers, polyolefins, copolymers thereof, or blends thereof. Specific examples of polymers that can be present in the support layer include polydimethylsiloxane, polydiethylsiloxane, polydi-iso-propylsiloxane, polydiphenylsiloxane, polyethersulfone, polyphenylsulfone, polysulfone, polyacrylonitrile, polyvinylidene fluoride, polyamide, polyimide, polyetherimide, polyetheretherketone, polyphenylene oxide, polybenzimidazole, polypropylene, polyethylene, partially fluorinated, perfluorinated or sulfonated derivatives thereof, copolymers thereof, or blends thereof. In some embodiments, the gas permeable polymer can be polysulfone or polyethersulfone. If desired, the support layer can include inorganic particles to increase the mechanical strength without altering the permeability of the support layer.

In certain embodiments, the support layer can comprise a gas permeable polymer disposed on a base. The base can be in any configuration configured to facilitate formation of a membrane suitable for use in a particular application. For example, the base can be a flat disk, a tube, a spiral wound, or a hollow fiber base. The base can be formed from any suitable material. In some embodiments, the layer can include a fibrous material. The fibrous material in the base can be a mesh (e.g., a metal or polymer mesh), a woven or non-woven fabric, a glass, fiberglass, a resin, a screen (e.g., a metal or polymer screen). In certain embodiments, the base can include a non-woven fabric (e.g., a non-woven fabric comprising fibers formed from a polyester).

### Selective Polymer Layer

The selective polymer layer can include a selective polymer matrix and optionally, graphene oxide dispersed within the selective polymer matrix. The selective polymer matrix can include a hydrophilic polymer, an amine-containing polymer (i.e., a fixed carrier), a mobile carrier (e.g., an alkanolamine or a salt thereof), a cross-linking agent, a CO₂-philic ether, or a combination thereof.

In other embodiments, the selective polymer matrix can include a combination of a hydrophilic polymer, cross-linking agent, and a mobile carrier (e.g., an alkanolamine or a salt thereof).

In some embodiments, selective polymer matrix can include a hydrophilic polymer, a cross-linking agent, a mobile carrier (e.g., an alkanolamine or a salt thereof), an amine-containing polymer, and a CO₂-philic ether. In some embodiments, selective polymer matrix can include a hydrophilic polymer, a crosslinking agent, a mobile carrier (e.g., an alkanolamine or a salt thereof), and an amine-containing polymer. In some embodiments, selective polymer matrix can include a hydrophilic polymer, a cross-linking agent, a mobile carrier (e.g., an alkanolamine or a salt thereof), and a CO₂-philic ether.

In some embodiments, the hydrophilic polymer (e.g., polyvinyl alcohol) is crosslinked. In some embodiments the hydrophilic polymer is crosslinked with aminosilanes.

The selective polymer matrix can include a crosslinked hydrophilic polymer, an amine-containing polymer, a mobile carrier (e.g., an alkanolamine or a salt thereof), a CO₂-philic ether, or a combination thereof. In some embodiments, selective polymer matrix can include a crosslinked hydrophilic polymer, an amine-containing polymer, a mobile carrier (e.g., an alkanolamine or a salt thereof), and a CO₂-philic ether. In some embodiments, selective polymer matrix can include a crosslinked hydrophilic polymer, an amine-containing polymer, and a mobile carrier (e.g., an alkanolamine or a salt thereof). In some embodiments, selective polymer matrix can include a crosslinked hydrophilic polymer and a mobile carrier (e.g., an alkanolamine or a salt thereof). In some embodiments, selective polymer matrix can include a crosslinked hydrophilic polymer, a mobile carrier (e.g., an alkanolamine or a salt thereof), and a CO₂-philic ether.

In some embodiments, selective polymer matrix can include an amine-containing polymer (e.g., polyvinylamine), a hydrophilic polymer (e.g., polyvinyl alcohol (PVA)), a cross-linking agent (e.g., aminosilane), and an alkanolamine or a salt thereof (e.g., 1-(2-hydroxyethyl)piperazine sarcosinate (HEPZ-Sar), monoethanolamine 2-aminoisobutyrate (MEA-AIBA), 2-(2-hydroxyethoxy)ethyl piperazine (HEEPZ), N-hydroxyethyl-N′-hydroxyethyl-ethylenediamine (BHEEDA), N-hydroxyethyl-N-methyl-N′-hydroxyethyl-N′-methyl-ethylenediamine (DMBHEEDA), or a combination thereof). In some embodiments, selective polymer matrix can include an amine-containing polymer (e.g., polyvinylamine), a hydrophilic polymer (e.g., polyvinyl alcohol), a cross-linking agent (e.g., aminosilane), an alkanolamine or a salt thereof (e.g., 1-(2-hydroxyethyl)piperazine sarcosinate (HEPZ-Sar), monoethanolamine 2-aminoisobutyrate (MEA-AIBA), 2-(2-hydroxyethoxy)ethyl piperazine (HEEPZ), N-hydroxyethyl-N′-hydroxyethyl-ethylenediamine (BHEEDA), N-hydroxyethyl-N-methyl-N′-hydroxyethyl-N′-methyl-ethylenediamine (DMBHEEDA), or a combination thereof), and a CO₂-philic ether (e.g., poly(ethylene glycol) dimethyl ether).

In some embodiments, selective polymer matrix can include a hydrophilic polymer (e.g., polyvinyl alcohol), a cross-linking agent (e.g., aminosilane), and an alkanolamine or a salt thereof (e.g., 1-(2-hydroxyethyl)piperazine sarcosinate (HEPZ-Sar), monoethanolamine aminoisobutyrate (MEA-AIBA), 2-(2-hydroxyethoxy)ethyl piperazine (HEEPZ), N-hydroxyethyl-N′-hydroxyethyl-ethylenediamine (BHEEDA), N-hydroxyethyl-N-methyl-N′-hydroxyethyl-N′-methyl-ethylenediamine (DMBHEEDA), or a combination thereof). In some embodiments, selective polymer matrix can include a hydrophilic polymer (e.g., polyvinyl alcohol), a cross-linking agent (e.g., aminosilane), an alkanolamine or a salt thereof (e.g., 1-(2-hydroxyethyl)piperazine sarcosinate (HEPZ-Sar), monoethanolamine 2-aminoisobutyrate (MEA-AIBA), 2-(2-hydroxyethoxy)ethyl piperazine (HEEPZ), N-hydroxyethyl-N′-hydroxyethyl-ethylenediamine (BHEEDA), N-hydroxyethyl-N-methyl-N′-hydroxyethyl-N′-methyl-ethylenediamine (DMBHEEDA), or a combination thereof), and a CO₂-philic ether (e.g., poly(ethylene glycol) dimethyl ether).

In some embodiments, selective polymer matrix can include an amine-containing polymer (e.g., polyvinylamine), a crosslinked hydrophilic polymer (e.g., aminosilane crosslinked polyvinyl alcohol), and an alkanolamine or a salt thereof (e.g., 1-(2-hydroxyethyl)piperazine sarcosinate (HEPZ-Sar), monoethanolamine aminoisobutyrate (MEA-AIBA), 2-(2-hydroxyethoxy)ethyl piperazine (HEEPZ), N-hydroxyethyl-N′-hydroxyethyl-ethylenediamine (BHEEDA), N-hydroxyethyl-N-methyl-N′-hydroxyethyl-N′-methyl-ethylenediamine (DMBHEEDA), or a combination thereof). In some embodiments, selective polymer matrix can include an amine-containing polymer (e.g., polyvinylamine), a crosslinked hydrophilic polymer (e.g., aminosilane crosslinked polyvinyl alcohol), an alkanolamine or a salt thereof (e.g., 1-(2-hydroxyethyl)piperazine sarcosinate (HEPZ-Sar), monoethanolamine 2-aminoisobutyrate (MEA-AIBA), 2-(2-hydroxyethoxy)ethyl piperazine (HEEPZ), N-hydroxyethyl-N′-hydroxyethyl-ethylenediamine (BHEEDA), N-hydroxyethyl-N-methyl-N′-hydroxyethyl-N′-methyl-ethylenediamine (DMBHEEDA), or a combination thereof), and a CO₂-philic ether (e.g., poly(ethylene glycol) dimethyl ether).

In some embodiments, selective polymer matrix can include a crosslinked hydrophilic polymer (e.g., aminosilane crosslinked polyvinyl alcohol), and an alkanolamine or a salt thereof (e.g., 1-(2-hydroxyethyl)piperazine sarcosinate (HEPZ-Sar), monoethanolamine aminoisobutyrate (MEA-AIBA), 2-(2-hydroxyethoxy)ethyl piperazine (HEEPZ), N-hydroxyethyl-N′-hydroxyethyl-ethylenediamine (BHEEDA), N-hydroxyethyl-N-methyl-N′-hydroxyethyl-N′-methyl-ethylenediamine (DMBHEEDA), or a combination thereof). In some embodiments, selective polymer matrix can include a crosslinked hydrophilic polymer (e.g., aminosilane crosslinked polyvinyl alcohol), an alkanolamine or a salt thereof (e.g., 1-(2-hydroxyethyl)piperazine sarcosinate (HEPZ-Sar), monoethanolamine aminoisobutyrate (MEA-AIBA), 2-(2-hydroxyethoxy)ethyl piperazine (HEEPZ), N-hydroxyethyl-N′-hydroxyethyl-ethylenediamine (BHEEDA), N-hydroxyethyl-N-methyl-N′-hydroxyethyl-N′-methyl-ethylenediamine (DMBHEEDA), or a combination thereof), and a CO₂-philic ether (e.g., poly(ethylene glycol) dimethyl ether).

In some embodiments, the selective polymer layer can be a selective polymer matrix through which gas permeates via diffusion or facilitated diffusion.

### Cross-Linking Agent

The selective polymer matrix can include a cross-linking agent. Cross-linking agents suitable for use in the selective polymer matrix can include, but are not limited to, aminosilane, formaldehyde, glutaraldehyde, maleic anhydride, glyoxal, divinylsulfone, toluenediisocyanate, trimethylol melamine, terephthalatealdehyde, epichlorohydrin, or vinyl acrylate, and combinations thereof. In some embodiments, the cross-linking agent can include aminosilane. In some embodiments, the cross-linking agent can include aminosilane and glyoxal. The selective polymer matrix can include any suitable amount of the cross-linking agent. For example, the selective polymer matrix can comprise 1 to 70 percent cross-linking agents by weight of the selective polymer matrix. In some embodiments, the cross-linking agent can be at least 30%, at least 35%, at least 40% or at least 50%. In some embodiments, the cross-linking agent can be 40% aminosilane and 20% glyoxal by weight of the selective polymer matrix. In some embodiments, the cross-linking agent can be 35% aminosilane and 25% glyoxal by weight of the selective polymer matrix.

In some cases, the cross-linking agent can be an aminosilane tetravalent single bonded Si with at least one substituent containing an amino group(s) defined by formula I

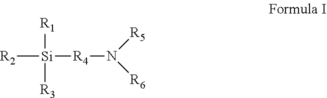

wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl, alkenyl, alkynyl, or alkoxy; and R₅ and R₆ are each independently selected from hydrogen, substituted or unsubstituted alkyl, alkenyl, alkynyl, alkoxy, aryl, heteroaryl, cycloalkyl, or heterocyclyl; or R₅ and R₆, together with the atoms to which they are attached, form a five- or a six-membered heterocycle;
wherein at least one R₁, R₂ or R₃ is a substituted or unsubstituted alkoxy.

In some cases, the cross-linking agent can be an aminosilane of Formula I, wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl; and R₅ and R₆ are each independently selected from hydrogen, substituted or unsubstituted alkyl, alkenyl, alkynyl, alkoxy, aryl, heteroaryl, cycloalkyl, or heterocyclyl; or R₅ and R₆, together with the atoms to which they are attached, form a five- or a six-membered heterocycle;
wherein at least one R₁, R₂ or R₃ is a substituted or unsubstituted alkoxy.

In some cases, the cross-linking agent can be an aminosilane of Formula I, wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl; and R₅ and R₆ are each independently selected from hydrogen, or substituted or unsubstituted alkyl;
wherein at least one R₁, R₂ or R₃ is a substituted or unsubstituted alkoxy.

In some cases, the cross-linking agent can be 3-aminopropyltriethoxysilane, N-[3-(trimethoxysilyl)propyl]ethylenediamine, (N,N-dimethylaminopropyl)timethoxysilane, (N,N-dimenthylaminopropyl) dimethoxymethylsilane, (N,N-dimethylaminopropyl) dimethylmethoxysilane, (N,N-diethylaminopropyl) dimethoxymethylsilane, (N,N-diisopropylaminopropyl) dimethoxysilane, (N,N-diisopropylaminopropyl) trimethoxysilane, or blends thereof (FIG. 8).

### Hydrophilic Polymers

The selective polymer matrix can include any suitable hydrophilic polymer. In some embodiments, the hydrophilic polymer is crosslinked with an aminosilane defined by Formula I. Examples of hydrophilic polymers suitable for use in the selective polymer layer can include polyvinylalcohol, polyvinylacetate, polyethylene oxide, polyvinylpyrrolidone, polyacrylamide, a polyamine such as polyallylamine, polyvinyl amine, or polyethylenimine, copolymers thereof, and blends thereof. In some embodiments, the hydrophilic polymer includes polyvinylalcohol.

The selective polymer matrix can include any suitable crosslinked hydrophilic polymer (e.g., aminosilane crosslinked polyvinyl alcohol). Examples of crosslinked hydrophilic polymers suitable for use in the selective polymer layer can include 3-aminopropyltriethoxysilane crosslinked polyvinyl alcohol, N-[3-(trimethoxysilyl)propyl]ethylenediamine crosslinked polyvinyl alcohol, (N,N-dimethylaminopropyl)timethoxysilane crosslinked polyvinyl alcohol, (N,N-dimenthylaminopropyl)dimethoxymethylsilane crosslinked polyvinyl alcohol, (N,N-dimethylaminopropyl)dimethylmethoxysilane crosslinked polyvinyl alcohol, (N,N-diethylaminopropyl)dimethoxymethylsilane crosslinked polyvinyl alcohol, (N,N-diisopropylaminopropyl)dimethoxysilane crosslinked polyvinyl alcohol, (N,N-diisopropylaminopropyl)trimethoxysilane crosslinked polyvinyl alcohol, or copolymers thereof, and blends thereof.

When present, the hydrophilic polymer can have any suitable molecular weight. For example, the hydrophilic polymer can have a weight average molecular weight of from 15,000 Da to 2,000,000 Da (e.g., from 50,000 Da to 200,000 Da). In some embodiments, the hydrophilic polymer can include polyvinyl alcohol having a weight average molecular weight of from 50,000 Da to 150,000 Da. In other embodiments, the hydrophilic polymer can be a high molecular weight hydrophilic polymer. For example, the hydrophilic polymer can have a weight average molecular weight of at least 500,000 Da (e.g., at least 700,000 Da, or at least 1,000,000 Da).

The selective polymer layer can include any suitable amount of the hydrophilic polymer. For example, in some cases, the selective polymer layer can include from 10% to 90% by weight (e.g., from 10% to 50% by weight, or from 10% to 30% by weight) hydrophilic polymer, based on the total weight of the components used to form the selective polymer layer.

When present, the crosslinked hydrophilic polymer can have any suitable molecular weight. For example, the crosslinked hydrophilic polymer can have a weight average molecular weight of from 15,000 Da to 2,000,000 Da (e.g., from 50,000 Da to 200,000 Da).

In some embodiments, the crosslinked hydrophilic polymer can include aminosilane crosslinked polyvinyl alcohol having a weight average molecular weight of from 50,000 Da to 150,000 Da. In other embodiments, the crosslinked hydrophilic polymer can be a high molecular weight crosslinked hydrophilic polymer. For example, the crosslinked hydrophilic polymer can have a weight average molecular weight of at least 500,000 Da (e.g., at least 700,000 Da, or at least 1,000,000 Da).

The selective polymer layer can include any suitable amount of the crosslinked hydrophilic polymer. For example, in some cases, the selective polymer layer can include from 10% to 90% by weight (e.g., from 10% to 50% by weight, or from 10% to 30% by weight) crosslinked hydrophilic polymer, based on the total weight of the components used to form the selective polymer layer.

### Mobile Carriers

The selective polymer matrix can comprise a mobile carrier comprising an alkanolamine or a salt thereof. Optionally, the selective polymer matrix can comprise an additional mobile carrier, such as one or more primary amine moieties and/or one or more secondary amine moieties.

In some embodiments, the mobile carrier (i.e., the alkanolamine or a salt thereof) can have a molecular weight of less than 1,000 Da (e.g., 800 Da or less, 500 or less, 300 Da or less, or 250 Da or less). In some embodiments, the mobile carrier can be non-volatile at the temperatures at which the membrane will be stored or used.

In some embodiments, the mobile carrier comprises an alkanolamine, such as a compound defined by the structure below:

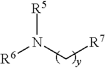

wherein
R⁵ and R⁶ are independently selected from hydrogen, alkyl, —ROH, —RNR⁵R⁶, or R⁵ and R⁶, together with the atoms to which they are attached, combine to form a 3 to 7 membered heterocycle;
R⁷ is —OH, —O—R—OH, or —R—OH;
R is alkyl;
y is an integer from 1 to 4; and
   wherein at least one of R⁵-R⁷ comprises a hydroxy group.

In certain embodiments, the alkanolamine can comprise one of the following:

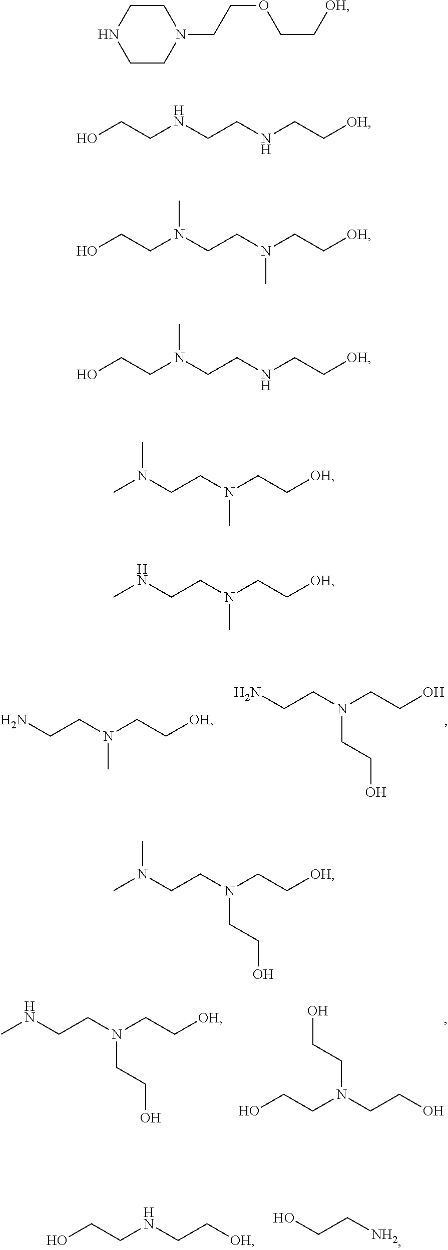

or a combination thereof.

In some embodiments, the mobile carrier can comprise an alkanolamine salt, such as an alkanolamine salt of an amino acid.

In some examples, the amino acid can comprise a compound defined by the formula below

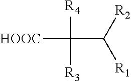

wherein, independently for each occurrence in the amino acid, each of R₁, R₂, R₃ and R₄ is selected from one of the following

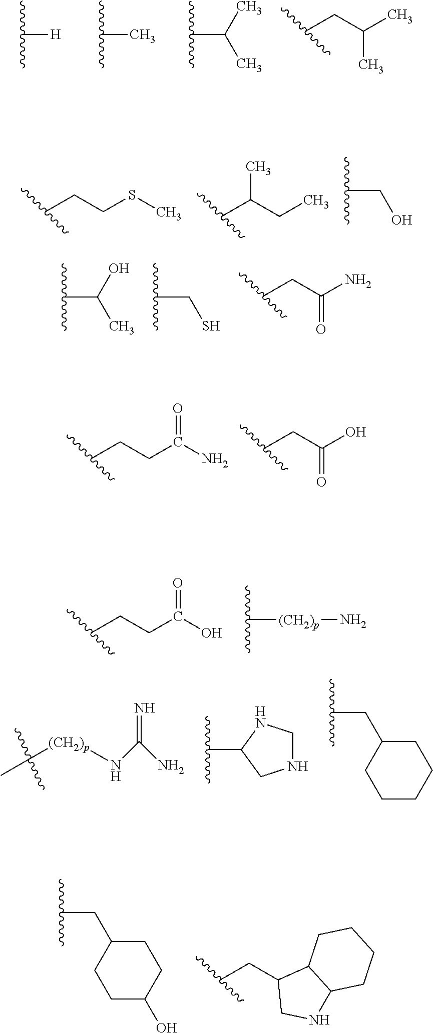

wherein at least one of R₁-R₄ comprises an amino group,
or R₁ and R₃, together with the atoms to which they are attached, form a five-membered heterocycle defined by the structure below when n is 1, or a six-membered heterocycle defined by the structure below when n is 2

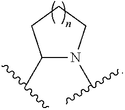

In some examples, the alkanolamine salt can comprise an alkanolamine defined by the structure below:

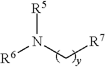

wherein
R⁵ and R⁶ are independently selected from hydrogen, alkyl, —ROH, —RNR⁵R⁶, or R⁵ and R⁶, together with the atoms to which they are attached, combine to form a 3 to 7 membered heterocycle;
R⁷ is —OH, —O—R—OH, or —R—OH;
R is alkyl;
y is an integer from 1 to 4; and
   wherein at least one of R⁵-R⁷ comprises a hydroxy group.

In some examples, the alkanolamine salt can comprise an alkanolamine-glycinate salt, an alkanolamine-sarcosinate salt, or an alkanolamine-aminoisobutyrate salt.

In some examples, the alkanolamine salt can comprise monoethanolamine aminoisobutyrate (MEA-AIBA), 2-(2-hydroxyethoxy)ethylamine 2-aminoisobutyrate (HEEA-AIBA), hydroxyethyl piperazine 2-aminoisobutyrate (HEPZ-AIBA), monoethanolamine sarcosinate (MEA-Sar), 2-(2-hydroxyethoxy)ethylamine sarcosinate (HEEA-Sar), and 1-(2-hydroxyethyl)piperazine sarcosinate (HEPZ-Sar), monoethanolamine glycinate (MEA-Gly), 2-(2-hydroxyethoxy)ethylamine glycinate (HEEA-Gly), 1-(2-hydroxyethyl)piperazine glycinate (HEPZ-Gly), diethanolamine 2-aminoisobutyrate (DEA-AIBA), diethanolamine sarconsinate (DEA-Sar), diethanolamine glycinate (DEA-Gly), triethanolamine 2-aminoisobutyrate (TEA-AIBA), triethanolamine sarconsinate (TEA-Sar), triethanolamine glycinate (TEA-Gly), or a combination thereof.

In some embodiments, the alkanolamine salt can be defined by a general formula below

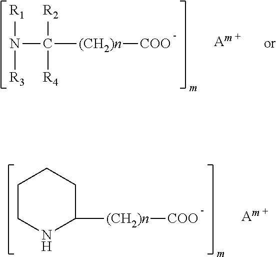

wherein R₁, R₂, R₃, and R₄ are hydrogen or hydrocarbon groups having from 1 to 4 carbon atoms, n is an integer ranging from 0 to 4, and
A^{m+} is defined by the formula below

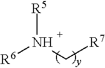

wherein
R⁵ and R⁶ are independently selected from hydrogen, alkyl, —ROH, —RNR⁵R⁶, or R⁵ and R⁶, together with the atoms to which they are attached, combine to form a 3 to 7 membered heterocycle;
R⁷ is —OH, —O—R—OH, or —R—OH;
R is alkyl;
y is an integer from 1 to 4; and
   wherein at least one of R⁵-R⁷ comprises a hydroxy group.

### Amine-Containing Polymer

In some embodiments, the amine-containing polymer can include one or more primary amine moieties and/or one or more secondary amine moieties. In these embodiments, the amine-containing polymer can serve as a “fixed-site carrier” and the low molecular weight amino compound can serve as a “mobile carrier.”

In some embodiments, the amino compound comprises an amine-containing polymer (also referred to herein as a “fixed-site carrier”). The amine-containing polymer can have any suitable molecular weight. For example, the amine-containing polymer can have a weight average molecular weight of from 5,000 Da to 5,000,000 Da, or from 50,000 Da to 2,000,000 Da. Suitable examples of amine-containing polymers include, but are not limited to, polyvinylamine, polyallylamine, polyethyleneimine, poly-N-isopropylallylamine, poly-N-tert-butylallylamine, poly-N-1,2-dimethylpropylallylamine, poly-N-methylallylamine, poly-N,N-dimethylallylamine, poly-2-vinylpiperidine, poly-4-vinylpiperidine, polyaminostyrene, chitosan, copolymers, and blends thereof. In some embodiments, the amine-containing polymer can comprise polyvinylamine (e.g., polyvinylamine having a weight average molecular weight of from 50,000 Da to 2,000,000 Da). In some embodiments when the amino compound comprises an amine-containing polymer, the selective polymer layer can comprise a blend of an amine-containing polymer and a hydrophilic polymer (e.g., an amine-containing polymer dispersed in a hydrophilic polymer matrix).

### CO₂-Philic Ethers

The selective polymeric matrix can further include a one or more CO₂-philic ethers. The CO₂-philic ether can be a polymer, oligomer, or small molecule containing one or more ether linkages. Examples of CO₂-philic ethers include alcohol ethers, polyalkylene alcohol ethers, polyalkylene glycols, poly(oxyalkylene)glycols, poly(oxyalkylene)glycol ethers, and ethoxylated phenol. In one embodiment, the CO₂-philic ether can comprise alkyl ethoxylate (C1-C6)-XEO X=1-30-linear or branched. In some embodiments, the CO₂-philic ether can comprise ethylene glycol butyl ether (EGBE), diethylene glycol monobutyl ether (DGBE), triethylene glycol monobutyl ether (TEGBE), ethylene glycol dibutyl ether (EGDE), polyethylene glycol monomethyl ether (mPEG), polyethylene glycol dimethyl ether (PEGDME), or any combination thereof.

### Graphene Oxide

The selective polymer layer can further include graphene oxide.

The term “graphene” refers to a one-atom-thick planar sheet of sp²-bonded carbon atoms that are densely packed in a honeycomb crystal lattice. In one embodiment, it refers to a single-layer version of graphite.

The term “graphene oxide” herein refers to functionalized graphene sheets (FGS)—the oxidized compositions of graphite. These compositions are not defined by a single stoichiometry. Rather, upon oxidation of graphite, oxygen-containing functional groups (e.g., epoxide, carboxyl, and hydroxyl groups) are introduced onto the graphite. Complete oxidation is not needed. Functionalized graphene generally refers to graphene oxide, where the atomic carbon to oxygen ratio starts at approximately 2. This ratio can be increased by reaction with components in a medium, which can comprise a polymer, a polymer monomer resin, or a solvent, and/or by the application of radiant energy. As the carbon to oxygen ratio becomes very large (e.g. approaching 20 or above), the graphene oxide chemical composition approaches that of pure graphene.

The term “graphite oxide” includes “graphene oxide”, which is a morphological subset of graphite oxide in the form of planar sheets. “Graphene oxide” refers to a graphene oxide material comprising either single-layer sheets or multiple-layer sheets of graphite oxide. Additionally, in one embodiment, a graphene oxide refers to a graphene oxide material that contains at least one single layer sheet in a portion thereof and at least one multiple layer sheet in another portion thereof. Graphene oxide refers to a range of possible compositions and stoichiometries. The carbon to oxygen ratio in graphene oxide plays a role in determining the properties of the graphene oxide, as well as any composite polymers containing the graphene oxide.

The abbreviation “GO” is used herein to refer to graphene oxide, and the notation GO(m) refers to graphene oxide having a C:O ratio of approximately “m”, where m ranges from 3 to about 20, inclusive. For example, graphene oxide having a C:O ratio of between 3 and 20 is referred to as “GO(3) to GO(20)”, where m ranges from 3 to 20, e.g. m=3, 4, 5, 6, 7, 8, 9, 10, 11, 12, 13, 14, 15, 16, 17, 18, 19 or 20, including all decimal fractions of 0.1 increments in between, e.g. a range of values of 3-20 includes 3.0, 3.1, 3.2, 3.3, 3.4, 3.5, 3.6, 3.7, 3.8, 3.9, 4.0, and so on up to 20. Thus, as used herein, the term GO(m) describes all graphene oxide compositions having a C:O ratio of from 3 to about 20. For example, a GO with a C:O ratio of 6 is referred to as GO(6), and a GO with a C:O ratio of 8, is referred to as GO(8), and both fall within the definition of GO(m).

As used herein, “GO(L)” refers to low C:O ratio graphene oxides having a C:O ratio of approximately “L”, wherein L is less than 3, e.g., in the range of from about 1, including 1, up to 3, and not including 3, e.g. about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, or about 2.9. In many embodiments, a GO(L) material has a C:O ratio of approximately 2. The designations for the materials in the GO(L) group is the same as that of the GO(m) materials described above, e.g., “GO(2)” refers to graphene oxide with a C:O ratio of 2.

In some embodiments, the graphene oxide can be GO((m). In some embodiments, the graphene oxide can be GO(L). In some embodiments, the graphene oxide can be nanoporous.

### Other Components

The selective polymer matrix can further include a base. The base can act as a catalyst to catalyze the cross-linking of the selective polymer matrix (e.g., cross-linking of a hydrophilic polymer with an amine-containing polymer). In some embodiments, the base can remain in the selective polymer matrix and constitute a part of the selective polymer matrix. Examples of suitable bases include potassium hydroxide, sodium hydroxide, lithium hydroxide, triethylamine, N,N-dimethylaminopyridine, hexamethyltriethylenetetraamine, potassium carbonate, sodium carbonate, lithium carbonate, and combinations thereof. In some embodiments, the base can include potassium hydroxide. The selective polymer matrix can comprise any suitable amount of the base. For example, the selective polymer matrix can comprise 1 to 40 percent base by weight of the selective polymer matrix.

The selective polymer layer further comprises carbon nanotubes dispersed within the selective polymer matrix. Any suitable carbon nanotubes (prepared by any suitable method or obtained from a commercial source) can be used. The carbon nanotubes can comprise single-walled carbon nanotubes, multiwalled carbon nanotubes, or a combination thereof.

In some cases, the carbon nanotubes can have an average diameter of a least 10 nm (e.g., at least 20 nm, at least 30 nm, or at least 40 nm). In some cases, the carbon nanotubes can have an average diameter of 50 nm or less (e.g., 40 nm or less, 30 nm or less, or 20 nm or less). In certain embodiments, the carbon nanotubes can have an average diameter ranging from any of the minimum values described above to any of the maximum values described above. For example, the carbon nanotubes can have an average diameter of from 10 nm to 50 nm (e.g., from 10 nm to 30 nm, or from 20 nm to 50 nm).

In some cases, the carbon nanotubes can have an average length of at least 50 nm (e.g., at least 100 nm, at least 200 nm, at least 300 nm, at least 400 nm, at least 500 nm, at least 600 nm, at least 700 nm, at least 800 nm, at least 900 nm, at least 1 μm, at least 5 μm, at least 10 μm, or at least 15 μm). In some cases, the carbon nanotubes can have an average length of 20 μm or less (e.g., 15 μm or less, 10 μm or less, 5 μm or less, 1 μm or less, 900 nm or less, 800 nm or less, 700 nm or less, 600 nm or less, 500 nm or less, 400 nm or less, 300 nm or less, 200 nm or less, or 100 nm or less).

In certain embodiments, the carbon nanotubes can have an average length ranging from any of the minimum values described above to any of the maximum values described above. For example, the carbon nanotubes can have an average length of from 50 nm to 20 μm (e.g., from 200 nm to 20 μm, or from 500 nm to 10 μm).

In some cases, the carbon nanotubes can comprise unfunctionalized carbon nanotubes. In other embodiments, the carbon nanotubes can comprise sidewall functionalized carbon nanotubes. Sidewall functionalized carbon nanotubes are well known in the art. Suitable sidewall functionalized carbon nanotubes can be prepared from unfunctionalized carbon nanotubes, for example, by creating defects on the sidewall by strong acid oxidation. The defects created by the oxidant can subsequently converted to more stable hydroxyl and carboxylic acid groups. The hydroxyl and carboxylic acid groups on the acid treated carbon nanotubes can then be coupled to reagents containing other functional groups (e.g., amine-containing reagents), thereby introducing pendant functional groups (e.g., amino groups) on the sidewalls of the carbon nanotubes. In some embodiments, the carbon nanotubes can comprise hydroxy-functionalized carbon nanotubes, carboxy-functionalized carbon nanotubes, amine-functionalized carbon nanotubes, or a combination thereof.

In some embodiments, the selective polymer layer can comprise at least 0.5% (e.g., at least 1%, at least 1.5%, at least 2%, at least 2.5%, at least 3%, at least 3.5%, at least 4%, or at least 4.5%) by weight carbon nanotubes, based on the total dry weight of the selective polymer layer. In some embodiments, the selective polymer layer can comprise 5% or less (e.g., 4.5% or less, 4% or less, 3.5% or less, 3% or less, 2.5% or less, 2% or less, 1.5% or less, or 1% or less) by weight carbon nanotubes, based on the total dry weight of the selective polymer layer.

The selective polymer layer can comprise an amount of carbon nanotubes ranging from any of the minimum values described above to any of the maximum values described above. For example, the selective polymer layer can comprise from 0.5% to 5% (e.g., from 1% to 3%) by weight carbon nanotubes, based on the total dry weight of the selective polymer layer.

If desired, the selective polymer layer can be surface modified by, for example, chemical grafting, blending, or coating to improve the performance of the selective polymer layer. For example, hydrophobic components may be added to the selective polymer layer to alter the properties of the selective polymer layer in a manner that facilitates greater fluid selectivity.

The total thickness of each layer in the membrane can be chosen such that the structure is mechanically robust, but not so thick as to impair permeability. In some embodiments, the selective polymer layer can have a thickness of from 50 nanometers to 25 microns (e.g., from 100 nanometers to 750 nanometers, from 250 nanometers to 500 nanometers, from 50 nm to 2 microns, from 50 nm to 20 microns, or from 1 micron to 20 microns). In some embodiments, the support layer can have a thickness of from 1 micron to 500 microns (e.g., from 50 to 250 microns). In some cases, the membranes disclosed herein can have a thickness of from 5 microns to 500 microns.

### Methods of Making

Methods of making these membranes are also disclosed herein. Methods of making membranes can include depositing a selective polymer layer on a support layer to form a selective layer disposed on the support layer. The selective polymer layer can comprise a selective polymer matrix and graphene oxide dispersed within the selective polymer matrix.

Optionally, the support layer can be pretreated prior to deposition of the selective polymer layer, for example, to remove water or other adsorbed species using methods appropriate to the support and the adsorbate. Examples of absorbed species are, for example, water, alcohols, porogens, and surfactant templates.

The selective polymer layer can be prepared by first forming a coating solution including the components of the selective polymer matrix (e.g., a hydrophilic polymer, a cross-linking agent, a low molecular weight amino compound, an amine-containing polymer, a CO₂-philic ether, or a combination thereof, and optionally a basic compound and/or graphene oxide in a suitable solvent). One example of a suitable solvent is water. In some embodiments, the amount of water employed will be in the range of from 50% to 99%, by weight of the coating solution. The coating solution can then be used in forming the selective polymer layer. For example, the coating solution can be coated onto a support later (e.g., a nanoporous gas permeable membrane) using any suitable technique, and the solvent may be evaporated such that a nonporous membrane is formed on the substrate. Examples of suitable coating techniques include, but are not limited to, “knife coating” or “dip coating”. Knife coating include a process in which a knife is used to draw a polymer solution across a flat substrate to form a thin film of a polymer solution of uniform thickness after which the solvent of the polymer solution is evaporated, at ambient temperatures or temperatures up to about 100° C. or higher, to yield a fabricated membrane. Dip coating include a process in which a polymer solution is contacted with a porous support. Excess solution is permitted to drain from the support, and the solvent of the polymer solution is evaporated at ambient or elevated temperatures. The membranes disclosed can be shaped in the form of hollow fibers, tubes, films, sheets, etc. In certain embodiments, the membrane can be configured in a flat sheet, a spiral-wound, a hollow fiber, or a plate-and-frame configuration.

In some embodiments, membranes formed from a selective polymer matrix containing for example, a hydrophilic polymer, a cross-linking agent, a low molecular weight amino compound, an amine-containing polymer, a CO₂-philic ether, and/or graphene oxide can be heated at a temperature and for a time sufficient for cross-linking to occur. In one example, cross-linking temperatures in the range from 80° C. to 100° C. can be employed. In another example, cross-linking can occur from 1 to 72 hours. The resulting solution can be coated onto the support layer and the solvent evaporated, as discussed above. In some embodiments, a higher degree of cross-linking for the selective polymer matrix after solvent removal takes place at about 100° C. to about 180° C., and the cross-linking occurs in from about 1 to about 72 hours.

An additive may be included in the selective polymer layer before forming the selective polymer layer to increase the water retention ability of the membrane. Suitable additives include, but are not limited to, polystyrenesulfonic acid-potassium salt, polystyrenesulfonic acid-sodium salt, polystyrenesulfonic acid-lithium salt, sulfonated polyphenyleneoxides, alum, and combinations thereof. In one example, the additive comprises polystyrenesulfonic acid-potassium salt.

In some embodiments, the method of making these membranes can be scaled to industrial levels.

### Methods of Use

The membranes disclosed herein can be used for separating gaseous mixtures. For example, provided are methods for separating a first gas from a feed gas comprising the first gas and one or more additional gases (e.g., at least a second gas). The method can include contacting any of the disclosed membranes (e.g., on the side comprising the selective polymer) with the feed gas under conditions effective to afford transmembrane permeation of the first gas. In some embodiments, the method can also include withdrawing from the reverse side of the membrane a permeate containing at least the first gas, wherein the first gas is selectively removed from the gaseous stream. The permeate can comprise at least the first gas in an increased concentration relative to the feed stream. The term “permeate” refers to a portion of the feed stream which is withdrawn at the reverse or second side of the membrane, exclusive of other fluids such as a sweep gas or liquid which may be present at the second side of the membrane.

The membrane can be used to separate fluids at any suitable temperature, including temperatures of 100′C or greater. For example, the membrane can be used at temperatures of from 100° C. to 180° C. In some embodiments, a vacuum can be applied to the permeate face of the membrane to remove the first gas. In some embodiments, a sweep gas can be flowed across the permeate face of the membrane to remove the first gas. Any suitable sweep gas can be used. Examples of suitable sweep gases include, for example, air, steam, nitrogen, argon, helium, and combinations thereof.

The first gas can include an acid gas. For example, the first gas can be carbon dioxide, hydrogen sulfide, or combinations thereof. In some embodiments, the membrane can be selective to carbon dioxide versus hydrogen, nitrogen, carbon monoxide, or combinations thereof. In some embodiments, the membrane can be selective to hydrogen sulfide versus hydrogen, nitrogen, carbon monoxide, or combinations thereof. In some embodiments, the acid gas may be derived from fossil fuels that require hydrogen purification for fuel cell, electricity generation, and hydrogenation applications, biogas for renewable energy, and natural gas for commercial uses. For example, the membranes may be employed in a fuel cell (e.g., to purify feed gases prior to entering the fuel cell). The membranes can also be used for removal of carbon dioxide from flue gas.

In certain embodiments, the feed gas comprises syngas. The first gas can comprise carbon dioxide and the second gas can comprise hydrogen. In these embodiments, the membranes described herein can be employed, for example, to decarbonize coal-derived syngas.

The permeance of the first gas or the acid gas can be at least 50 GPU (e.g., 75 GPU or greater, 100 GPU or greater, 150 GPU or greater, 200 GPU or greater, 250 GPU or greater, 300 GPU or greater, 350 GPU or greater, 400 GPU or greater, or 450 GPU or greater) at 107° C. and a feed pressure of 15-40 bar (e.g., 35 bar).

The permeance of the first gas or the acid gas can be 500 GPU or less at 107° C. and a feed pressure of 15-40 bar (e.g., 35 bar) (e.g., 450 GPU or less, 400 GPU or less, 350 GPU or less, 300 GPU or less, 250 GPU or less, 200 GPU or less, 150 GPU or less, 100 GPU or less, or 75 GPU or less).

The permeance of the first gas or the acid gas through the membrane can vary from any of the minimum values described above to any of the maximum values described above. For example, the permeance of the first gas or the acid gas can be from 50 GPU to 500 GPU at 107° C. and a feed pressure of 15-40 bar (e.g., 35 bar) (e.g., from 50 GPU to 400 GPU, from 50 GPU to 300 GPU, from 50 GPU to 250 GPU, from 100 GPU to 500 GPU, from 80 GPU to 300 GPU, from 100 GPU to 300 GPU, or from 80 GPU to 500 GPU).

The membrane can exhibit a first gas/second gas selectivity of at least 10 at 107° C. and 31.7 bar feed pressure. In some embodiments, the membrane can exhibit a first gas/second gas selectivity of 500 or less at 107° C. and a feed pressure of 15-40 bar (e.g., 35 bar). For example, the membrane can exhibit a first gas/second gas selectivity of 10 or greater, 25 or greater, 50 or greater, 75 or greater, 100 or greater, 125 or greater, 150 or greater, 175 or greater, 200 or greater, 225 or greater, 250 or greater, 275 or greater, 300 or greater, 325 or greater, 350 or greater, 375 or greater, 400 or greater, 425 or greater, 450 or greater, or 475 or greater at 107° C. and a feed pressure of 15-40 bar. In some embodiments, the permeance and selectivity of the membrane for the first gas or the acid gas can vary at higher or lower temperatures.

In some cases, the membrane can exhibit a first gas/second gas selectivity of at least 10 at 107° C. and a feed pressure of 15-40 bar (e.g., 35 bar). For example, the membrane can exhibit a first gas/second gas selectivity of at least 25 (e.g., at least 50, at least 75, at least 100, at least 125, at least 150, at least 175, at least 200, at least 225, at least 250, at least 275, at least 300, at least 325, at least 350, at least 375, at least 400, at least 425, at least 450, or at least 475) at 107° C. and a feed pressure of 15-40 bar (e.g., 35 bar). In some embodiments, the membrane can exhibit a first gas/second gas selectivity of 500 or less (e.g., 475 or less, 450 or less, 425 or less, 400 or less, 375 or less, 350 or less, 325 or less, 300 or less, 275 or less, 250 or less, 225 or less, 200 or less, 175 or less, 150 or less, 125 or less, 100 or less, 75 or less, 50 or less, or 25 or less) at 107° C. and a feed pressure of 15-40 bar (e.g., 35 bar).

In certain embodiments, the membrane can exhibit a first gas/second gas selectivity ranging from any of the minimum values described above to any of the maximum values described above. For example, in certain embodiments, the membrane can exhibit a first gas/second gas selectivity of from 10 to 500 at 107° C. and a feed pressure of 15-40 bar (e.g., 35 bar) (e.g., from 10 to 400 at 107° C. and 35 bar feed pressure, from 75 to 400 at 107° C. and a feed pressure of 15-40 bar (e.g., 35 bar), from 100 to 400 at 107° C. and 35 bar feed pressure, from 10 to 350 at 107° C. and 35 bar feed pressure, from 75 to 350 at 107° C. and a feed pressure of 15-40 bar (e.g., 35 bar), from 100 to 350 at 107° C. and 35 bar feed pressure, from 10 to 250 at 107° C. and a feed pressure of 15-40 bar (e.g., 35 bar), from 75 to 250 at 107° C. and 35 bar feed pressure, from 50 to 500 at 107° C. and a feed pressure of 15-40 bar (e.g., 35 bar), from 50 to 250 at 107° C. and a feed pressure of 15-40 bar (e.g., 35 bar), or from 100 to 250 at 107° C. and a feed pressure of 15-40 bar (e.g., 35 bar)). The first gas/second gas selectivity can be measured using standard methods for measuring gas permeance known in the art, such as those described in the examples below.

In some embodiments, the membrane can exhibit a first gas permeance of from 50 GPU to 500 GPU at 107° C. and a feed pressure of 15-40 bar (e.g., 35 bar) (e.g., from 50 GPU to 400 GPU, from 50 GPU to 300 GPU, from 50 GPU to 250 GPU, from 100 GPU to 500 GPU, from 80 GPU to 300 GPU, from 100 GPU to 300 GPU, or from 80 GPU to 500 GPU) and a first gas/second gas selectivity of from 50 to 500 at 107° C. and a feed pressure of 15-40 bar (e.g., 35 bar) (e.g., from 10 to 400 at 107° C. and a feed pressure of 15-40 bar (e.g., 35 bar), from 75 to 400 at 107° C. and a feed pressure of 15-40 bar (e.g., 35 bar), from 100 to 400 at 107° C. and a feed pressure of 15-40 bar (e.g., 35 bar), from 10 to 350 at 107° C. and a feed pressure of 15-40 bar (e.g., 35 bar), from 75 to 350 at 107° C. and a feed pressure of 15-40 bar (e.g., 35 bar), from 100 to 350 at 107° C. and a feed pressure of 15-40 bar (e.g., 35 bar), from 10 to 250 at 107° C. and a feed pressure of 15-40 bar (e.g., 35 bar), from 75 to 250 at 107° C. and a feed pressure of 15-40 bar (e.g., 35 bar), from 50 to 500 at 107° C. and a feed pressure of 15-40 bar (e.g., 35 bar), from 50 to 250 at 107° C. and a feed pressure of 15-40 bar (e.g., 35 bar), or from 100 to 250 at 107° C. and a feed pressure of 15-40 bar (e.g., 35 bar)).

In some embodiments, the first gas permeance and first gas/second gas selectivity remains stable for 5 hours or more (e.g., 6 hours or more, 12 hours or more, 24 hours or more, 36 hours or more, 48 hours or more, 60 hours or more, 72 hours or more, 84 hours or more, 96 hours or more, or 108 hours or more). In some embodiments, the first gas permeance and first gas/second gas selectivity remains stable for 120 hours or less (e.g., 108 hours or less, 96 hours or less, 84 hours or less, 72 hours or less, 60 hours or less, 48 hours or less, 36 hours or less, 24 hours or less, 12 hours or less, 6 hours or less).

In certain embodiments, the first gas permeance and first gas/second gas selectivity remains stable for a period of time ranging from any of the minimum values described above to any of the maximum values described above. For example, in certain embodiments, the first gas permeance and first gas/second gas selectivity remains stable for from 5 hours to 120 hours, (e.g., from 12 hours to 120 hours, from 24 hours to 120 hours, from 36 hours to 120 hours, from 48 hours to 120 hours, from 60 hours to 120 hours, from 72 hours to 120 hours, from 84 hours to 120 hours, from 96 hours to 120 hours, from 108 to 120 hours, from 12 hours to 72 hours, from 12 hours to 60 hours, from 6 hours to 120 hours, from 6 hours to 72 hours, or from 6 hours to 36 hours).

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

By way of non-limiting illustration, examples of certain embodiments of the present disclosure are given below.

### EXAMPLES

### Overview

Disclosed are CO₂-selective membranes incorporated with hydroxyethyl-containing amines as mobile carriers for hydrogen purification from hydrogen-containing gaseous streams with high CO₂ partial pressures, including coal- and/or natural gas-derived synthesis gases. The hydroxyethyl-containing amine carriers included monoethanolamine 2-aminoisobutyrate (MEA-AIBA), 1-(2-hydroxyethyl)piperazine 2-aminoisobutyrate (HEPZ-AIBA), 2-(2-hydroxyethoxy)ethyl piperazine (HEEPZ), N,N′-bis(2-hydroxyethyl)ethylenediamine (BHEEDA), and N,N′-dimethyl-N,N′-bis(2-hydroxyethyl)ethylenediamine (DMBHEEDA). For hosting the low MW amine carrier, a water-swellable polymer network was synthesized from poly(vinyl alcohol) (PVA) crosslinked by a bidentate tertiary aminosilane and glyoxal, which was blended with high MW polyvinylamine as fixed-site carrier. Nanoporous graphene oxide was dispersed in the membrane to avoid membrane compaction upon high feed pressure. The membrane demonstrated excellent CO₂/H₂ separation performance at 107° C. and 35 bar feed pressure with a CO₂ partial pressure of 13.8 bar, which corresponds to the feed CO₂ partial pressure in the coal-derived syngas.

### Materials and Methods

Piperazine (PZ, 99%), 2-(1-piperazinyl)ethylamine (PZEA, 99%), 1-(2-hydroxyethyl)piperazine (HEPZ, 98%), monoethanolamine (MEA, 99%), 1-[2-(2-hydroxyethoxy)ethyl]piperazine (HEEPZ, 95%), N,N′-bis(2-hydroxyethyl)ethylenediamine (BHEEDA, 95%), N,N′-dimethyl-N,N′-bis(2-hydroxyethyl)ethylenediamine (DMBHEEDA, 90%), 2-aminoisobutyric acid (AIBA, 98%), sarcosine (Sar, 98%), glyoxal (40%), and acetic acid (glacial) were purchased from Sigma-Aldrich (Milwaukee, WI). (N,N-diethylaminopropyl)dimethoxymethylsilane (95%) was acquired from Gelest, Inc. (Morrisville, PA). PVA (Poval S-2217, 92%) was given by Kuraray America Inc. (Houston, TX). Monolayer graphene oxide (GO) was purchased from TCI America (Portland, OR, USA) in the form of solid flakes. All the chemicals except GO were used as received without further purification.

The amine-containing polymer can be, for example, polyvinylamine (PVAm), polyallylamine, polyethyleneimine, copolymers thereof, and a combination thereof. The amine-containing polymer employed in these examples, PVAm, was purified from a commercial product named Polymin® VX from BASF (Vandalia, IL). The PVAm can have a high weight average molecular weight of 2,000 kDa. In some examples, the amine-containing polymer can have a weight average molecular weight of from 300 to 3,000 kDa, but in certain cases, it can be higher than 1,000 kDa.

### Example 1: Preparation of Nanoporous GO

The GO was dispersed in water (˜1 mg/ml) using an ultrasonication probe with a power of 2500 W for 3 hours. KOH solution (50 wt. %) was added slowly into the GO dispersion with a KOH-to-GO weight ratio of 14:1 to prevent the precipitation of GO. The mixture was further ultrasonicated for 30 minutes. After this, the water was evaporated in a convection oven at 60° C., followed by a further drying in a vacuum oven at 60° C. overnight. The resultant solid was annealed at 200° C. for 2 hours to create pores on the GO basal plane. After the thermal treatment, the solid was washed by DI water under vacuum filtration until the filtrate reached a pH of 7. The purified nanoporous GO (nGO) was dispersed in water again (˜1 mg/ml) by an ultrasonication bath.

### Example 2: Crosslinking of PVA Via Aminosilane

The general reaction scheme of the crosslinking of PVA by (N,N-diethylaminopropyl)dimethoxymethylsilane is exemplified in the following. The pH of an ethanol/water mixture (95/5 wt./wt.) was adjusted to 6 via acetic acid. The aminosilane was added with stirring to yield a 2 wt. % solution. The solution was kept under stirring for 5 minutes to allow for the formation of silanol. A calculated amount of the solution was then added in an 8 wt. % PVA aqueous solution at room temperature to aim for 25% crosslinking. After a homogenization for 5 minutes, extra acetic acid was added to yield a pH of 4. The system was then refluxed at 80° C. for 2 h. To further tighten up the polymer network, an extra portion of the hydroxyl groups on the PVA was converted to acetal linkages via glyoxal. Experimentally, a calculated amount of the glyoxal solution (40 wt. %) was added into the mixture under vigorous agitation. The final crosslinking was carried out at 80° C. for 2 hours. The pH of the gel was then adjusted to 12 by strong basic anion-exchange resin.

### Example 3: Coating Solution and Membrane Preparation

Certain amount of the purified PVAm solution was added in the crosslinked PVA solution under vigorous agitation. The nGO dispersion with a concentration of ˜1 mg/ml was added dropwise to the polymer solution by a 10-μL glass capillary tube under vigorous agitation, aiming for 1 wt. % nGO loading in the final total solid of the coating solution. The mixture was transferred to a 15-mL conical centrifuge tube, in which it was homogenized by the ⅛″ Microtip sonication probe with a 50% amplitude until uniformly dispersed. The sonication was carried out in an ice bath. The water introduced by the nGO dispersion was vaporized by a nitrogen purge.

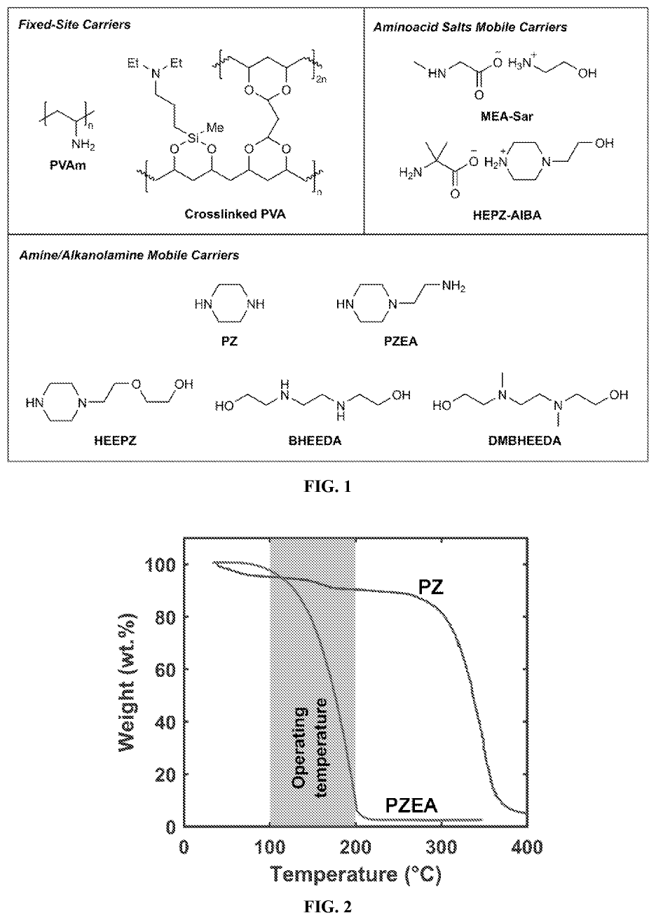

The aminoacid salt mobile carriers were synthesized by reacting an amine base, MEA or HEPZ, with an aminoacid, Sar or AIBA. The stoichiometric amount of Sar or AIBA was added in an aqueous solution of an amine under vigorous mixing. The solution was mixed at room temperature for 2 h before use. Other alkanolamine mobile carriers, including PZ, PZEA, HEEPZ, BHEEDA, and DMBHEEDA, were used without further modification. The chemical structures of the fixed-site and mobile carriers are shown in FIG. 1.

Certain amount of the mobile carrier solutions, including the aminoacid and alkanolamine, were incorporated in the nGO dispersion to form the coating solution. After centrifugation at 8,000×g for 3 min to remove any air bubbles, the coating solution was coated on a nanoporous polysulfone (PSf) substrate by a GARDCO adjustable micrometer film applicator (Paul N. Gardner Company, Pompano Beach, FL) with a controlled gap setting. The membrane was dried in a fume hood at room temperature for 30 min, then cured at 120° C. for 6 h.

### Example 4: Gas Permeation Measurements

The transport properties of the composite membrane were measured by a Wicke-Kallenbach permeation apparatus [2]. The membranes were tested at 107° C. and 35 bar feed pressure with a simulated syngas containing 4% water and 6000 ppm H₂S with balance of CO₂ and H₂. The feed side CO₂ partial pressure was kept at 13.8 bar, which corresponded to the feed CO₂ partial pressure before the bulk CO₂ removal. The permeate pressure was maintained at 1 psig. After leaving the gas permeation cell, the water vapors in both the retentate and the permeate were trapped in respective water knockout vessels. The dry gas compositions of both gas streams were analyzed using a gas chromatograph that was equipped with a thermal conductivity detector (Model 6890 N, Agilent Technologies, Palo Alto, CA) and a stainless steel micropacked column (80/100 mesh Carboxen 1004, Sigma-Aldrich, St. Louis, MO).

### Example 5

Comparative: Not in Accordance with the Membranes described herein

In this example, PZ and PZEA were used as the mobile carriers to facilitate CO₂ transport in a polymer matrix formed by crosslinked PVA and PVAm.

1 g of crosslinked PVA aqueous solution (8 wt. % concentration, 25 mol. % crosslinked by aminosilane and 10 mol. % crosslinked by glyoxal) was prepared by the method described in Example 2. 0.1 g PVAm aqueous solution (1 wt. %) was introduced to mediate the viscosity. Then, 8 g of nGO dispersion (˜0.1 wt. %) was added in the polymer solution dropwise under vigorous mixing. After this, the mixture was sonicated to re-disperse. Afterwards, the water introduced by the nGO dispersion was evaporated by N₂. Finally, 0.28 g PZ or PZEA was added in the dispersion to form a homogeneous coating solution. A centrifugation at 8,000×g for 3 min was conducted to remove any air bubbles entrapped in the coating solution. The coating solution was coated on the nanoporous PSf substrate by a GARDCO adjustable micrometer film applicator, resulting in a selective layer thickness of 15 μm. The membrane was dried in a fume hood at room temperature for 30 min, then cured at 120° C. for 6 h.

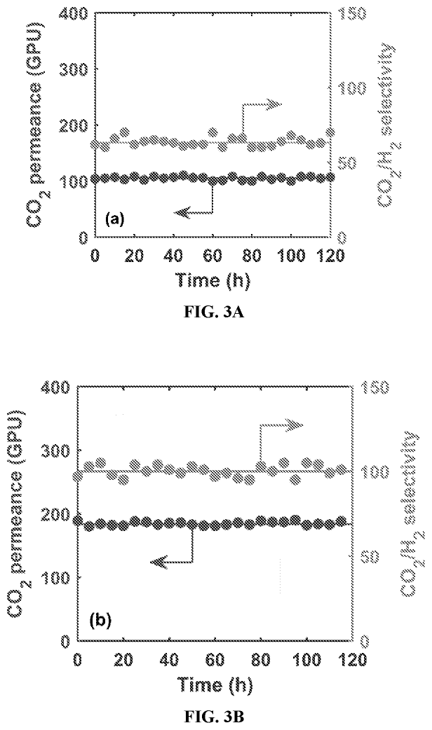

The CO₂/H₂ separation performances were tested at a CO₂ partial pressure of 13.8 bar, and the results are shown in Table 1. Neither membrane showed a stable performance. The membrane containing PZ exhibited an initial CO₂ permeance of 22 GPU with a CO₂/H₂ selectivity of 12, but the CO₂ permeance quickly reduced to 2 GPU within 2 h. A similar trend was observed for the membrane containing PZEA, the permeance of which reduced from 43 to 2 GPU within 5 h. The membrane instability was attributed to the low boiling point of PZ (146° C.) and PZEA (222° C.) and their relatively high vapor pressures, resulting in the volatility loss to the gas phases on the feed and permeate sides. In order to access their thermal stability, thermogravimetric analysis was carried out, and the results are shown in FIG. 2. As seen, both multiamines exhibited significant weight losses between 100-200° C., which suggested that these multiamines could leach out of the membranes during the gas permeation measurements.

TABLE 1
CO₂/H₂ separation performance of
membranes containing PZ and PZEA.

| Mobile carrier | CO₂ permeance (GPU) | CO₂/H₂ selectivity |
|---|---|---|
| PZ | 22 → 2 | 12 → 1.1 |
| PZEA | 43 → 2 | 22 → 1.0 |

### Example 6: Aminoacid Salt Mobile Carriers

In order to address the membrane stability issue of the multiamines, aminoacid salts synthesized by deprotonating an aminoacid with an alkanolamine were used as the mobile carriers to facilitate CO₂ transport in a polymer matrix formed by crosslinked PVA and PVAm. The aminoacid salts employed included MEA-Sar and HEPZ-AIBA.

1 g of crosslinked PVA aqueous solution (8 wt. % concentration, 25 mol. % crosslinked by aminosilane and 10 mol. % crosslinked by glyoxal) was prepared by the method described in Example 2. 0.1 g PVAm aqueous solution (1 wt. %) was introduced to mediate the viscosity. Then, 8 g of nGO dispersion (˜0.1 wt. %) was added in the polymer solution dropwise under vigorous mixing. After this, the mixture was sonicated to re-disperse. Afterwards, the water introduced by the nGO dispersion was evaporated by N₂. Finally, 0.28 g MEA-Sar or HEPZ-AIBA was added in the dispersion to form a homogeneous coating solution. A centrifugation at 8,000×g for 3 min was conducted to remove any air bubbles entrapped in the coating solution. The coating solution was coated on a nanoporous PSf substrate by a GARDCO adjustable micrometer film applicator, resulting in a selective layer thickness of 15 μm. The membrane was dried in a fume hood at room temperature for 30 min, then cured at 120° C. for 6 h.

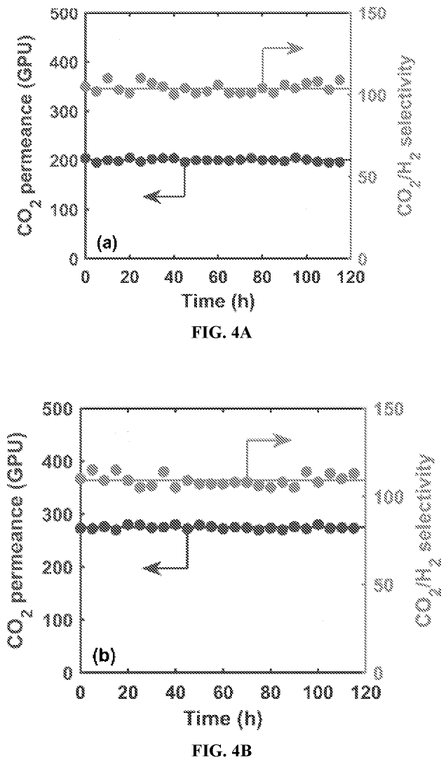

FIG. 3 (a) and (b) show the CO₂/H₂ separation performances of membranes containing MEA-Sar and HEPZ-AIBA, respectively, for 120 h. As seen, the membrane containing MEA-Sar exhibited an average CO₂ permeance of 105 GPU with a CO₂/H₂ selectivity of 64 and remained stable for 120 h. Similarly, the membrane containing HEPZ-AIBA also showed a stable performance with a permeance of 184 GPU and a CO₂/H₂ selectivity of 100. The improved membrane stability was attributed to the strong ionic interaction of the aminoacid salts, which resulted in their negligible volatility losses under the testing conditions. Compared with MEA-Sar, HEPZ-AIBA rendered a higher CO₂ permeance. MEA-Sar contained a secondary amino group, which reacts with CO₂ to form a zwitterion. This zwitterion is deprotonated by another amine to form a carbamate ion, which is stable:

CO₂+R—NH₂ [symbol] R—NH₂⁺—COO⁻

R—NH₂⁺—COO⁻+R—NH₂ [symbol] R—NH—COO⁻+R—NH₃+

The sum of these two reactions is as follows:

CO₂+2R—NH₂ [symbol] R—NH—COO⁻+R—NH₃⁺

Overall, 2 moles of amine are needed for 1 mole of CO₂. For the sterically hindered amino group in HEPZ-AIBA, the carbamate is unstable and subject to hydrolysis, resulting in the formation of bicarbonate and the regeneration of the amine:

CO₂+R₁—NH—R₂ [symbol] R₁R₂—NH⁺—COO⁻

R₁R₂—NH⁺—COO⁻+H₂O [symbol] R₁R₂—NH₂⁺+HCO₃⁻

The sum of these two reactions is in the following:

CO₂+R₁—NH—R₂+H₂O [symbol] R₁R₂—NH₂⁺+HCO₃⁻

Overall, 1 mole of amine can fixate 1 mole of CO₂ [7]. Here, R, R₁ and R₂ represent alkyl substituents. Therefore, the steric hindrance of HEPZ-AIBA improved the solubility of CO₂ in the membrane, and thereby the CO₂ permeance.

### Example 7: Alkanolamine Mobile Carriers

Alkanolamines were used in this example to improve the membrane stability.

1 g of crosslinked PVA aqueous solution (8 wt. % concentration, 25 mol. % crosslinked by aminosilane and 10 mol. % crosslinked by glyoxal) was prepared by the method described in Example 2. 0.1 g PVAm aqueous solution (1 wt. %) was introduced to mediate the viscosity. Then, 8 g of nGO dispersion (˜0.1 wt. %) was added in the polymer solution dropwise under vigorous mixing. After this, the mixture was sonicated to re-disperse. Afterwards, the water introduced by the nGO dispersion was evaporated by N₂. Finally, 0.28 g HEEPZ, BHEEDA, or DMBHEEDA was added in the dispersion to form a homogeneous coating solution. A centrifugation at 8,000×g for 3 min was conducted to remove any air bubbles entrapped in the coating solution. The coating solution was coated on a nanoporous PSf substrate by a GARDCO adjustable micrometer film applicator, resulting in a selective layer thickness of 15 μm. The membrane was dried in a fume hood at room temperature for 30 min, then cured at 120° C. for 6 h.

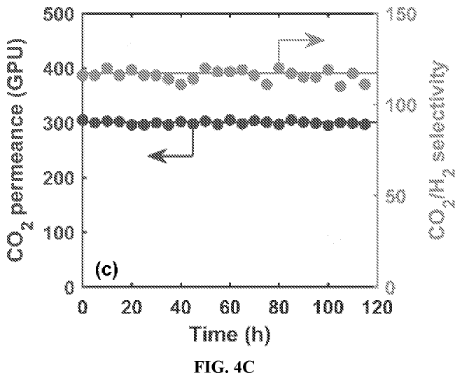

FIG. 4 shows the CO₂/H₂ separation performances of membranes containing HEEPZ, BHEEDA, and DMBHEEDA for 120 h. As seen, the membrane containing HEEPZ exhibited an average CO₂ permeance of 200 GPU with a CO₂/H₂ selectivity of 105 and remained stable for 120 h. Similarly, the membrane containing BHEEDA also showed a stable performance with a permeance of 275 GPU and a CO₂/H₂ selectivity of 111. The membrane containing DMBHEEDA showed the highest CO₂ permeance of 301 GPU with a stable CO₂/H₂ selectivity of 115. These three alkanolamines all contained ethoxy group(s) that could form hydrogen bonds with the crosslinked polymer network. The enhanced intermolecular interaction reduced the volatility of these low MW moieties, and thereby the improved membrane stability compared to the multiamines in Example 5.

The ethoxy group also promoted the chemisorption of CO₂ in the membrane. This is particularly the case for DMBHEEDA, in which the two tertiary amino groups only react with CO₂ to form a bicarbonate:

CO₂+R₁—N—R₂R₃+H₂O [symbol] R₁R₂R₃—NH⁺+HCO₃⁻

The ethoxy group could also form a strong hydrogen bond with the bicarbonate ion. As a consequence, the ethoxy group stabilized the bicarbonate species and enhanced the CO₂ solubility in the membrane.

### REFERENCES

[1]K. Ramasubramanian, Y Zhao, W. S. W. Ho, CO₂ capture and H₂ purification: Prospects for CO₂-selective membrane processes, AIChE J. 59 (2013) 1033-1045.
[2]R. Xing, W. S. W. Ho, Crosslinked polyvinylalcohol-polysiloxane/fumed silica mixed matrix membranes containing amines for CO₂/H₂ separation, J. Membr. Sci. 367 (2011) 91-102.
[3]T. Fout, A. Zoelle, D. Keairns, M. Turner, M. Woods, N. Kuehn, V. Shah, V. Chou, and L. Pinkerton, “Cost and Performance Baseline for Fossil Energy Plants Volume b: Bituminous Coal (IGCC) to Electricity Revision 2b—Year Dollar Update”, National Energy Technology Laboratory Report, DOE/NETL-2015/1727 (2015).
[4]Y Zhao, B. T. Jung, L. Ansaloni, W. S. W. Ho, Multiwalled carbon nanotube mixed matrix membranes containing amines for high pressure CO₂/H₂ separation, J. Membr. Sci. 459 (2014) 233-243.
[5]L. Ansaloni, Y Zhao, B. T. Jung, K. Ramasubramanian, M. G. Baschetti, W. S. W. Ho, Facilitated transport membranes containing amino-functionalized multi-walled carbon nanotubes for high-pressure CO₂ separations, J. Memb. Sci. 490 (2015) 18-28.
[6]Z. Qiao, Z. Wang, S. Yuan, J. Wang, S. Wang, Preparation and characterization of small molecular amine modified PVAm membranes for CO₂/H₂ separation, J. Membr. Sci. 475 (2015) 290-302.
[7]Y Zhao, W. S. W. Ho, CO₂-selective membranes containing sterically hindered amines for CO₂/H₂ separation, Ind. Eng. Chem. Res., 52 (2012) 8774-8782.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

What is claimed is:

1. A membrane comprising:
a support layer; and
a selective polymer layer disposed on the support layer, the selective polymer layer comprising a selective polymer matrix,
wherein the selective polymer matrix comprises a mobile carrier comprising an alkanolamine or a salt thereof.

2. The membrane of claim 1, wherein the mobile carrier has a molecular weight of less than 1,000 Da.

3. The membrane of any one of claims 1-2, wherein the mobile carrier comprises an alkanolamine.

4. The membrane of any one of claims 1-3, wherein the alkanolamine is defined by the structure below: 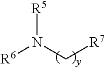
wherein
R⁵ and R⁶ are independently selected from hydrogen, alkyl, —ROH, —RNR⁵R⁶, or R⁵ and R⁶, together with the atoms to which they are attached, combine to form a 3 to 7 membered heterocycle;
R⁷ is —OH, —O—R—OH, or —R—OH;
R is alkyl;
y is an integer from 1 to 4; and
wherein at least one of R⁵-R⁷ comprises a hydroxy group.

5. The membrane of claim 4, wherein the alkanolamine comprises 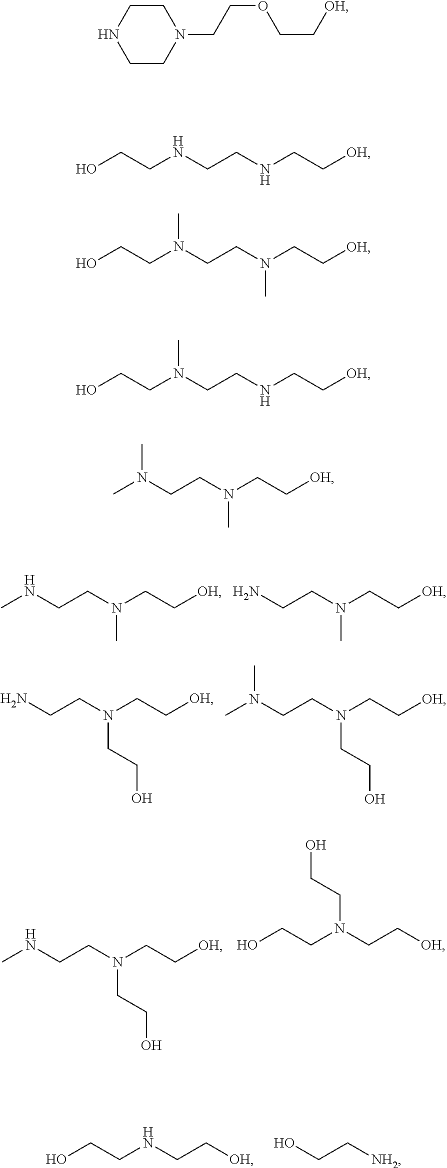
or a combination thereof.

6. The membrane of any of claims 1-5, wherein the mobile carrier comprises an alkanolamine salt.

7. The membrane of claim 6, wherein the alkanolamine salt comprises an alkanolamine salt of an amino acid.

8. The membrane of claim 7, wherein the amino acid comprises a compound defined by the formula below 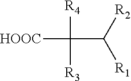
wherein, independently for each occurrence in the amino acid, each of R₁, R₂, R₃ and R₄ is selected from one of the following 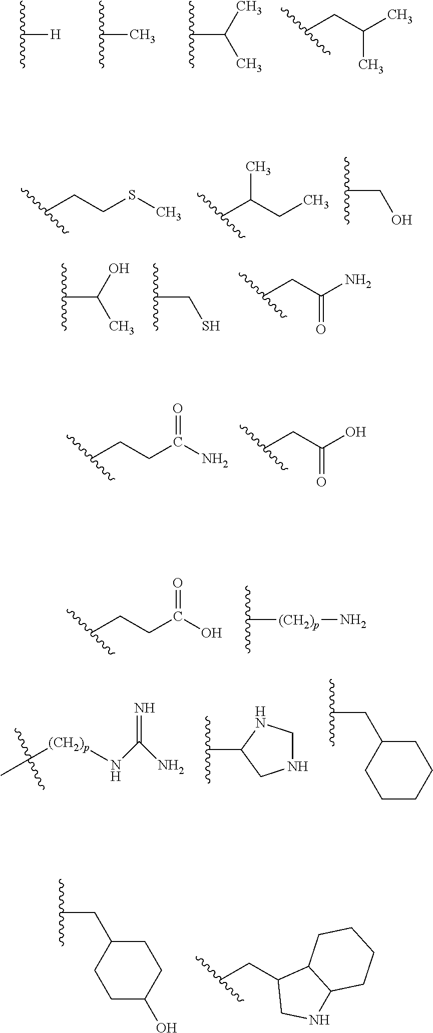
wherein at least one of R₁-R₄ comprises an amino group,
or R₁ and R₃, together with the atoms to which they are attached, form a five-membered heterocycle defined by the structure below when n is 1, or a six-membered heterocycle defined by the structure below when n is 2

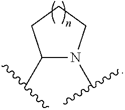

9. The membrane of any one of claims 6-8, wherein the alkanolamine salt comprises an alkanolamine-glycinate salt, a alkanolamine-sarcosinate salt, or an alkanolamine-aminoisobutyrate salt.

10. The membrane of any one of claims 6-9, wherein the alkanolamine salt comprises an alkanolamine defined by the structure below: 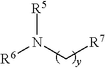
wherein
R⁵ and R⁶ are independently selected from hydrogen, alkyl, —ROH, —RNR⁵R⁶, or R⁵ and R⁶, together with the atoms to which they are attached, combine to form a 3 to 7 membered heterocycle;
R⁷ is —OH, —O—R—OH, or —R—OH;
R is alkyl;
y is an integer from 1 to 4; and
wherein at least one of R⁵-R⁷ comprises a hydroxy group.

11. The membrane of any one of claims 6-10, wherein the alkanolamine salt comprises monoethanolamine aminoisobutyrate (MEA-AIBA), 2-(2-hydroxyethoxy)ethylamine 2-aminoisobutyrate (HEEA-AIBA), hydroxyethyl piperazine 2-aminoisobutyrate (HEPZ-AIBA), monoethanolamine sarcosinate (MEA-Sar), 2-(2-hydroxyethoxy)ethylamine sarcosinate (HEEA-Sar), and 1-(2-hydroxyethyl)piperazine sarcosinate (HEPZ-Sar), monoethanolamine glycinate (MEA-Gly), 2-(2-hydroxyethoxy)ethylamine glycinate (HEEA-Gly), 1-(2-hydroxyethyl)piperazine glycinate (HEPZ-Gly), diethanolamine 2-aminoisobutyrate (DEA-AIBA), diethanolamine sarconsinate (DEA-Sar), diethanolamine glycinate (DEA-Gly), triethanolamine 2-aminoisobutyrate (TEA-AIBA), triethanolamine sarconsinate (TEA-Sar), triethanolamine glycinate (TEA-Gly), or a combination thereof.

12. The membrane of any of claims 6-11, wherein the alkanolamine salt is defined by a general formula below 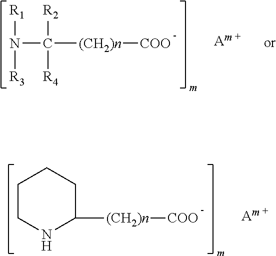
wherein R₁, R₂, R₃, and R₄ are hydrogen or hydrocarbon groups having from 1 to 4 carbon atoms, n is an integer ranging from 0 to 4, and
A^{m+} is defined by the formula below 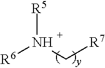
wherein
R⁵ and R⁶ are independently selected from hydrogen, alkyl, —ROH, —RNR⁵R⁶, or R⁵ and R⁶, together with the atoms to which they are attached, combine to form a 3 to 7 membered heterocycle;
R⁷ is —OH, —O—R—OH, or —R—OH;
R is alkyl;
y is an integer from 1 to 4; and
wherein at least one of R⁵-R⁷ comprises a hydroxy group.

13. The membrane of any one of claims 1-12, wherein the selective polymer matrix further comprises a hydrophilic polymer, an aminosilane cross-linking agent, amine-containing polymer, a CO₂-philic ether, or a combination thereof.

14. The membrane of any one of claims 1-13, wherein the selective polymer layer further comprises graphene oxide dispersed within the selective polymer matrix.

15. The membrane of any one of claims 1-14, wherein the selective polymer matrix comprises a hydrophilic polymer and an aminosilane cross-linking agent.

16. The membrane of claim 1-15, wherein the selective polymer matrix further comprises a CO₂-philic ether.

17. The membrane of any one of claims 1-16, further comprising a second cross-linking agent selected from the group consisting of formaldehyde, glutaraldehyde, maleic anhydride, glyoxal, divinylsulfone, toluenediisocyanate, trimethylol melamine, terephthalatealdehyde, epichlorohydrin, vinyl acrylate, and combinations thereof.

18. The membrane of any one of claims 13-17, wherein the aminosilane cross-linking agent is an aminosilane tetravalent single bonded Si with at least one substituent containing an amino group(s) defined by formula I below 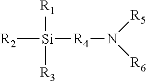
wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl, alkenyl, alkynyl, or alkoxy; and R₅ and R₆ are each independently selected from hydrogen, substituted or unsubstituted alkyl, alkenyl, alkynyl, alkoxy, aryl, heteroaryl, cycloalkyl, or heterocyclyl; or R₅ and R₆, together with the atoms to which they are attached, form a five- or a six-membered heterocycle;
wherein at least one R₁, R₂ or R₃ is a substituted or unsubstituted alkoxy.

19. The membrane of any one of claims 13-18, wherein the aminosilane cross-linking agent is selected from the group consisting of 3-aminopropyltriethoxysilane, N-[3-(trimethoxysilyl)propyl]ethylenediamine, (N,N-dimethylaminopropyl)timethoxysilane, (N,N-dimenthylaminopropyl) dimethoxymethylsilane, (N,N-dimethylaminopropyl)dimethylmethoxysilane, (N,N-diethylaminopropyl)dimethoxymethylsilane, (N,N-diisopropylaminopropyl)dimethoxysilane, (N,N-diisopropylaminopropyl)trimethoxysilane, and blends thereof.

20. The membrane of any one of claims 13-19, wherein the hydrophilic polymer comprises a polymer selected from the group consisting of polyvinylalcohol, polyvinylacetate, polyethylene oxide, polyvinylpyrrolidone, polyacrylamide, and copolymers thereof, or blends thereof.

21. The membrane of any one of claims 1-20, wherein the selective polymer matrix further comprises a crosslinked hydrophilic polymer.

22. The membrane of claim 21, wherein the crosslinked hydrophilic polymer is an aminosilane crosslinked polyvinyl alcohol.

23. The membrane of claim 22, wherein the crosslinked hydrophilic polymer is selected from the group consisting of 3-aminopropyltriethoxysilane crosslinked polyvinyl alcohol, N-[3-(trimethoxysilyl)propyl]ethylenediamine crosslinked polyvinyl alcohol, (N,N-dimethylaminopropyl)timethoxysilane crosslinked polyvinyl alcohol, (N,N-dimenthylaminopropyl)dimethoxymethylsilane crosslinked polyvinyl alcohol, (N,N-dimethylaminopropyl)dimethylmethoxysilane crosslinked polyvinyl alcohol, (N,N-diethylaminopropyl)dimethoxymethylsilane crosslinked polyvinyl alcohol, (N,N-diisopropylaminopropyl)dimethoxysilane crosslinked polyvinyl alcohol, (N,N-diisopropylaminopropyl)trimethoxysilane crosslinked polyvinyl alcohol, and copolymers thereof, or blends thereof.

24. The membrane of any one of claims 13-23, wherein the CO₂-philic ether is chosen from an alcohol ether, a polyalkylene alcohol ether, a polyalkylene glycol, a poly(oxyalkylene)glycol, a poly(oxyalkylene)glycol ether, an ethoxylated phenol, and combinations thereof.

25. The membrane of any one of claims 13-24, wherein the CO₂-philic ether is an alkyl ethoxylate (C₁-C₆)-XEO X=1-30-linear or branched.

26. The membrane of any one of claims 13-25, wherein the CO₂-philic ether is chosen from ethylene glycol butyl ether (EGBE), diethylene glycol monobutyl ether (DGBE), triethylene glycol monobutyl ether (TEGBE), ethylene glycol dibutyl ether (EGDE), polyethylene glycol monomethyl ether (mPEG), poly(ethylene glycol) dimethyl ether (PEGDME), or any combination thereof.

27. The membrane of any one of claims 1-26, wherein the selective polymer matrix further comprises an amine-containing polymer.

28. The membrane of claim 27, wherein the amine-containing polymer is selected from the group consisting of polyvinylamine, polyallylamine, polyethyleneimine, poly-N-isopropylallylamine, poly-N-tert-butylallylamine, poly-N-1,2-dimethylpropylallylamine, poly-N-methylallylamine, poly-N,N-dimethylallylamine, poly-2-vinylpiperidine, poly-4-vinylpiperidine, polyaminostyrene, chitosan, copolymers, and blends thereof.

29. The membrane of claim 28, wherein the amine-containing polymer comprises polyvinylamine.

30. The membrane of any of claims 14-29, wherein the graphene oxide has a carbon to oxygen ratio of from 3 to 20.

31. The membrane of any of claims 14-30, wherein the graphene oxide has a carbon to oxygen ratio of from 1 to 3.

32. The membrane of any of claims 14-31, wherein the selective polymer layer comprises from 0.01% to 5% by weight graphene oxide, based on the total dry weight of the selective polymer layer.

33. The membrane of any of claims 14-32, wherein the graphene oxide is nanoporous.

34. The membrane of any of claims 14-33, wherein the selective polymer layer further comprises carbon nanotubes dispersed within the selective polymer matrix.

35. The membrane of any of claims 1-34, wherein the support layer comprises a gas permeable polymer.

36. The membrane of claim 35, wherein the gas permeable polymer comprises a polymer chosen from polyamides, polyimides, polypyrrolones, polyesters, sulfone-based polymers, nitrile-based polymers, polymeric organosilicones, fluorinated polymers, polyolefins, copolymers thereof, and blends thereof.

37. The membrane of claim 36, wherein the gas permeable polymer comprises polyethersulfone or polysulfone.

38. The membrane of any of claims 1-37, wherein the support layer comprises a gas permeable polymer disposed on a base.

39. The membrane of claim 38, wherein the base comprises a non-woven fabric.

40. The membrane of claim 39, wherein the non-woven fabric comprises fibers formed from a polyester.

41. The membrane of any of claims 1-40, wherein the membrane is configured in a flat sheet, a spiral-wound, a hollow fiber, or a plate-and-frame configuration.

42. The membrane of any one of claims 1-41, wherein the membrane is selectively permeable to an acidic gas.

43. The membrane of any one of claims 1-42, wherein the membrane is selectively permeable to a fluid selected from the group consisting of carbon dioxide, hydrogen sulfide, water, and combinations thereof.

44. The membrane of any of claims 1-43, wherein the membrane has a CO₂:H₂ selectivity of at least 50 at 107° C. and a feed pressure of 15-40 bar, such as a feed pressure of 35 bar.

45. The membrane of any of claims 1-44, wherein the membrane has a CO₂:H₂ selectivity of from 50 to 500 at 107° C. and a feed pressure of 15-40 bar, such as a feed pressure of 35 bar.

46. The membrane of any of claims 1-45, wherein the membrane has a CO₂:H₂ selectivity of from 50 to 250 at 107° C. and a feed pressure of 15-40 bar, such as a feed pressure of 35 bar.

47. The membrane of any one of claims 1-46, wherein the membrane has a CO₂ permeance of at least 50 GPU at 107° C. and a feed pressure of 15-40 bar, such as a feed pressure of 35 bar.

48. The membrane of any one of claims claim 1-47, wherein the membrane has a CO₂ permeance of from 50 GPU to 500 GPU at 107° C. and a feed pressure of 15-40 bar, such as a feed pressure of 35 bar.

49. The membrane of any one of claims 1-48, wherein the membrane has a CO₂ permeance of from 80 GPU to 300 GPU at 107° C. and a feed pressure of 15-40 bar, such as a feed pressure of 35 bar.

50. The membrane of any one of claims 1-49, wherein the CO₂ permeance and CO₂:H₂ selectivity remains stable for 5 hours or more, such as from 5 hours to 120 hours, from 12 hours to 120 hours, from 24 hours to 120 hours, from 36 hours to 120 hours, from 48 hours to 120 hours, from 60 hours to 120 hours, from 72 hours to 120 hours, from 84 hours to 120 hours, from 96 hours to 120 hours, from 108 to 120 hours, from 12 hours to 72 hours, from 12 hours to 60 hours, from 6 hours to 120 hours, from 6 hours to 72 hours, or from 6 hours to 36 hours.

51. A method for separating a first gas from a feed gas stream, the method comprising contacting a membrane defined by any of claims 1-50 with the feed gas stream comprising the first gas under conditions effective to afford transmembrane permeation of the first gas.

52. The method of claim 51, wherein the feed gas comprises hydrogen, carbon dioxide, hydrogen sulfide, carbon monoxide, nitrogen, methane, steam, or combinations thereof.

53. The method of claim 52, wherein the feed gas comprises syngas.

54. The method of any of claims 52-53, wherein the first gas is chosen from carbon dioxide, hydrogen sulfide, and combinations thereof.

55. The method of any of claims 52-54, wherein the feed gas comprises a second gas selected from the group consisting of nitrogen, hydrogen, carbon monoxide, and combinations thereof, and
wherein the membrane exhibits a first gas/second gas selectivity of from 50 to 300 at 107° C. and a feed pressure of 15-40 bar, such as a feed pressure of 35 bar.

56. The method of claim 52-55, wherein the permeance of the first gas is at least 50 GPU at 107° C. and a feed pressure of 15-40 bar, such as a feed pressure of 35 bar.

57. The method of claim 52-56, wherein the permeance of the first gas is from 50 GPU to 500 GPU at 107° C. and a feed pressure of 15-40 bar, such as a feed pressure of 35 bar.

58. The method of claim 52-57, wherein the permeance of the first gas is from 80 GPU to 300 GPU at 107° C. and a feed pressure of 15-40 bar, such as a feed pressure of 35 bar.

59. The method of claim 52-58, wherein the membrane exhibits a first gas/second gas selective of from 50 to 500 at 107° C. and a feed pressure of 15-40 bar, such as a feed pressure of 35 bar.

60. The method of claim 52-59, wherein the membrane exhibits a first gas permeance of 50 GPU to 500 GPU at 107° C. and a feed pressure of 15-40 bar, such as a feed pressure of 35 bar, and first gas/second gas selectivity of from 50 to 300 at 107° C. and a feed pressure of 15-40 bar, such as a feed pressure of 35 bar.

61. The method of any one of claims 52-60, wherein the first gas permeance and first gas/second gas selectivity remains stable for 5 hours or more, such as from 5 hours to 120 hours, from 12 hours to 120 hours, from 24 hours to 120 hours, from 36 hours to 120 hours, from 48 hours to 120 hours, from 60 hours to 120 hours, from 72 hours to 120 hours, from 84 hours to 120 hours, from 96 hours to 120 hours, from 108 to 120 hours, from 12 hours to 72 hours, from 12 hours to 60 hours, from 6 hours to 120 hours, from 6 hours to 72 hours, or from 6 hours to 36 hours.

62. A method of making a membrane comprising depositing a selective polymer layer on a support layer, the selective polymer layer comprising a selective polymer matrix and graphene oxide dispersed within the selective polymer matrix.
